(19) United States
(12) Patent Application Publication
(10) Pub. No.: US 2015/0095313 A1
(43) Pub. Date: Apr. 2, 2015

(54) COMPUTER-READABLE MEDIUM, APPARATUS AND METHOD

(71) Applicant: FUJITSU LIMITED, Kawasaki-shi (JP)

(72) Inventors: TOMOHIKO HIRAGUCHI, Kawasaki (JP); Junji Shimaoka, Yokohama (JP); Kazuaki Nishimura, Otaku (JP); Shuichi Kido, kannami (JP); Hiroshi Fukuyama, Sagamihara (JP)

(73) Assignee: FUJITSU LIMITED, Kawasaki-shi (JP)

(21) Appl. No.: 14/477,264

(22) Filed: Sep. 4, 2014

(30) Foreign Application Priority Data
Oct. 2, 2013 (JP) 2013-206972

(51) Int. Cl. G06F 17/30

(52) U.S. Cl. CPC G06F 17/30519
USPC 707/722

(57) ABSTRACT

A non-transitory computer-readable medium including a program, which when executed by a computer, causes the computer to execute a process including: referring to data-size information indicating size of data corresponding to a query for acquiring the data stored in a storage, the data-size information and the data being stored in the storage and the data-size information being associated with the data in the storage; specifying an amount of the data corresponding to the query in accordance with the data-size information; and determining whether allows an output of the data corresponding to the query in accordance with the specified amount of the data and a data amount acceptable for the storage.

### CROSS-REFERENCE TO RELATED APPLICATIONS

This application is based upon and claims the benefit of priority of the prior Japanese Patent Application No. 2013-206972, filed on Oct. 2, 2013, the entire contents of which are incorporated herein by reference.

### FIELD

The embodiments discussed herein are related to a computer-readable medium, an apparatus and a method.

### BACKGROUND

In a case where an information processing device acquires data from a database, the information processing device sends an acquisition request for data (called a query) to the database, and the database transmits, to the information processing device, data extracted based on the query.

Japanese Laid-open Patent Publication No. 2010-122956 discusses such a technique.

### SUMMARY

According to an aspect of the invention, a non-transitory computer-readable medium including a program, which when executed by a computer, causes the computer to execute a process including: referring to data-size information indicating size of data corresponding to a query for acquiring the data stored in a storage, the data-size information and the data being stored in the storage and the data-size information being associated with the data in the storage; specifying an amount of the data corresponding to the query in accordance with the data-size information; and determining whether allows an output of the data corresponding to the query in accordance with the specified amount of the data and a data amount acceptable for the storage.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a database system;

FIG. 2 is a diagram illustrating an example of a module configuration of a mediation unit;

FIG. 3 is a diagram illustrating an outline of table generation according to a first embodiment;

FIG. 4 is a diagram illustrating a flow of table generation processing;

FIG. 5 is a diagram illustrating an example of metadata;

FIG. 6 is a diagram illustrating outlines of data addition and data update according to the first embodiment;

FIG. 7 is a diagram illustrating a flow of data addition processing;

FIG. 8 is a diagram illustrating a flow of data update processing;

FIG. 9 is a diagram illustrating a flow of first data extraction processing;

FIG. 10 is a diagram illustrating an outline of size calculation according to the first embodiment;

FIG. 11 is a diagram illustrating a flow of first size calculation processing;

FIG. 12 is a diagram illustrating an outline of actual data acquisition according to the first embodiment;

FIG. 13 is a diagram illustrating a flow of first actual data acquisition processing;

FIG. 14 is a diagram illustrating an example of a table according to a second embodiment;

FIG. 15 is a diagram illustrating an outline of table generation according to the second embodiment;

FIG. 16 is a diagram illustrating an example of metadata;

FIG. 17 is a diagram illustrating an example of the metadata;

FIG. 18 is a diagram illustrating outlines of data addition and data update according to the second embodiment;

FIG. 19 is a diagram illustrating an outline of size calculation according to the second embodiment;

FIG. 20 is a diagram illustrating an outline of actual data acquisition according to the second embodiment;

FIG. 21 is a diagram illustrating an example of a module configuration of an application unit;

FIG. 22 is a diagram illustrating a flow of processing by the application unit;

FIG. 23 is a diagram illustrating an example of a module configuration of a mediation unit according to a fourth embodiment;

FIG. 24 is a diagram illustrating an outline of determination of availability of outputting according to the fourth embodiment;

FIG. 25 is a diagram illustrating an outline of determination of availability of outputting according to the fourth embodiment;

FIG. 26 is a diagram illustrating a flow of second data extraction processing according to the fourth embodiment;

FIG. 27 is a diagram illustrating a flow of second size calculation processing according to the fourth embodiment;

FIG. 28 is a diagram illustrating a flow of first determination processing of availability of outputting;

FIG. 29 is a diagram illustrating an outline of an output error according to a fifth embodiment;

FIG. 30 is a diagram illustrating an outline of actual data acquisition according to the fifth embodiment;

FIG. 31 is a diagram illustrating an outline of an output error according to the fifth embodiment;

FIG. 32 is a diagram illustrating an outline of actual data acquisition according to the fifth embodiment;

FIG. 33 is a diagram illustrating a flow of third data extraction processing according to the fifth embodiment;

FIG. 34 is a diagram illustrating a flow of second determination processing of availability of outputting according to the fifth embodiment;

FIG. 35 is a diagram illustrating a flow of second actual data acquisition processing according to the fifth embodiment;

FIG. 36 is a diagram illustrating an outline of table generation according to a sixth embodiment;

FIG. 37 is a diagram illustrating an example of metadata;

FIG. 38 is a diagram illustrating outlines of data addition and data update according to the sixth embodiment;

FIG. 39 is a diagram illustrating an outline of size calculation according to the sixth embodiment;

FIG. 40 is a diagram illustrating an outline of actual data acquisition according to the sixth embodiment;

FIG. 41 is a diagram illustrating an outline of determination of availability of outputting according to a seventh embodiment;

FIG. 42 is a diagram illustrating an outline of an output error according to an eighth embodiment;

FIG. 43 is a diagram illustrating an outline of actual data acquisition according to the eighth embodiment;

FIG. 44 is a diagram illustrating an outline of table generation according to a ninth embodiment;

FIG. 45 is a diagram illustrating an example of metadata;

FIG. 46 is a diagram illustrating outlines of data addition and data update according to the ninth embodiment;

FIG. 47 is a diagram illustrating an outline of size calculation according to the ninth embodiment;

FIG. 48 is a diagram illustrating an outline of actual data acquisition according to the ninth embodiment;

FIG. 49 is a diagram illustrating an outline of determination of availability of outputting according to a tenth embodiment;

FIG. 50 is a diagram illustrating an outline of an output error according to an eleventh embodiment;

FIG. 51 is a diagram illustrating an outline of actual data acquisition according to the eleventh embodiment; and

FIG. 52 is a hardware configuration diagram of a computer.

### DESCRIPTION OF EMBODIMENTS

First, considerations by inventors will be described. In a case where the size of data extracted in response to a query is large, it takes more-than-expected time to transmit the data in some cases. In addition, in a case where the size of the extracted data exceeds a predetermined upper limit, the transmission of the data is interrupted in some cases.

For example, in a case where a database storing therein so-called big data is used, the size of extracted data greatly fluctuates, and furthermore, it is difficult to predict the size thereof. Therefore, in an application that deals with such a database, there has been a problem that it is difficult for processing to become stable.

According to the after-mentioned example, it is possible to predict availability of outputting of data extracted from a database.

### First Embodiment

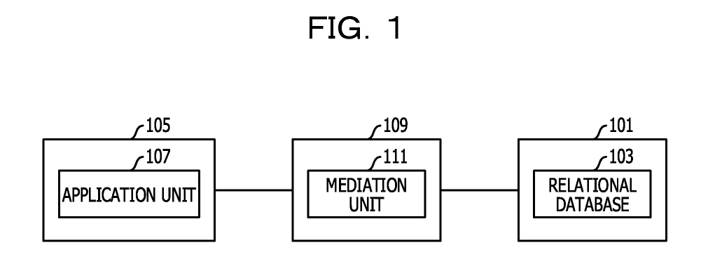

FIG. 1 illustrates an example of the configuration of a database system. A relational database device 101 includes a relational database 103. While here an example of utilizing the relational database 103 is illustrated, another database may be used.

An application device 105 includes an application unit 107. The application unit 107 utilizes data stored in the relational database 103.

In the present embodiment, a mediation device 109 is provided between the application device 105 and the relational database device 101. The application device 105 and the mediation device 109 are connected to each other through a network such as, for example, a local area network (LAN) or the Internet. The mediation device 109 and the relational database device 101 are connected to each other through a network such as, for example, a LAN or the Internet. The application device 105, the mediation device 109, and the relational database device 101 may be connected to a shared network.

The mediation device 109 includes a mediation unit 111. The mediation unit 111 mediates the use of the relational database 103 by the application unit 107. In other words, the mediation unit 111 receives a request from the application unit 107, and issues an instruction to the relational database 103 in response to that request. In addition, the mediation unit 111 receives a result from the relational database 103, and returns a response to the application unit 107 in response to that result.

The mediation unit 111 generates a structured query language (SQL) statement in response to a data extraction request, and transmits that SQL statement to the relational database 103. In the present embodiment, this SQL statement is referred to as a data extraction instruction. The mediation unit 111 receives a result set from the relational database 103, and the mediation unit 111 generates extraction result data following a predetermined format, and transmits that extraction result data to the application unit 107. The format used at this time is, for example, comma separated values (CSV), an extensible markup language (XML), a hypertext markup language (HTML), or the like.

Specifically, the SQL statement generated by the mediation unit 111 at this time is a SELECT statement. A record in a table is identified in accordance with the SELECT statement, and data is extracted from that record. Therefore, the SELECT statement includes an extraction condition and an output item.

The extraction condition is a condition for identifying the record. The extraction condition is set in a WHERE clause within the SELECT statement. As the extraction condition, for example, an arbitrary value or an arbitrary range of value for an arbitrary item is specified.

The output item is the item of data to be output. The output item is set in a SELECT clause within the SELECT statement. As the output item, for example, an arbitrary item is specified. The number of specified items may be one, or two or more.

While here an example where the mediation unit 111 is provided in the mediation device 109 is illustrated, the mediation unit 111 may be provided in the relational database device 101. In addition, the mediation unit 111 may be provided in the application device 105. The application unit 107, the mediation unit 111, and the relational database device 101 may be provided in a same device.

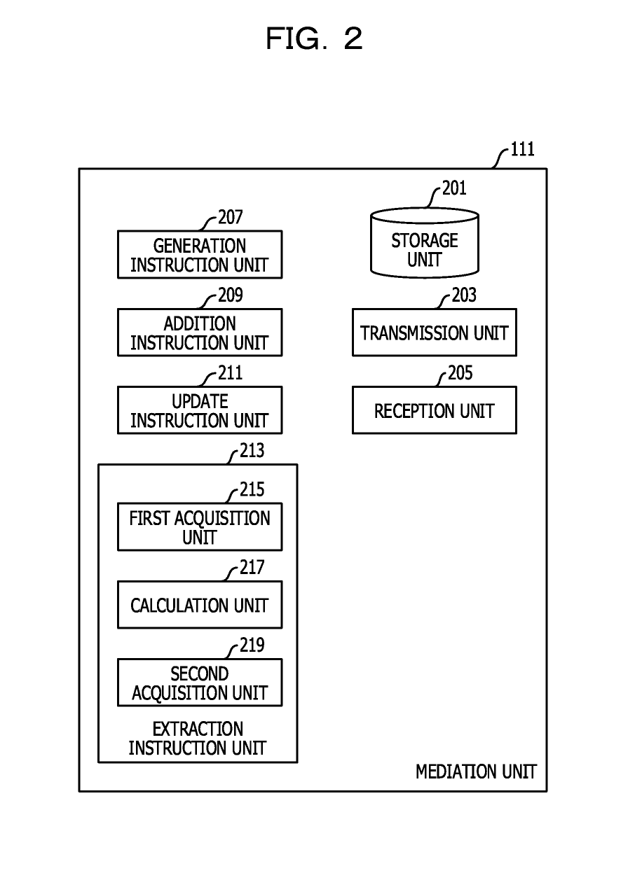

FIG. 2 illustrates an example of the module configuration of a mediation unit. The mediation unit 111 includes a storage unit 201, a transmission unit 203, a reception unit 205, a generation instruction unit 207, an addition instruction unit 209, an update instruction unit 211, and an extraction instruction unit 213.

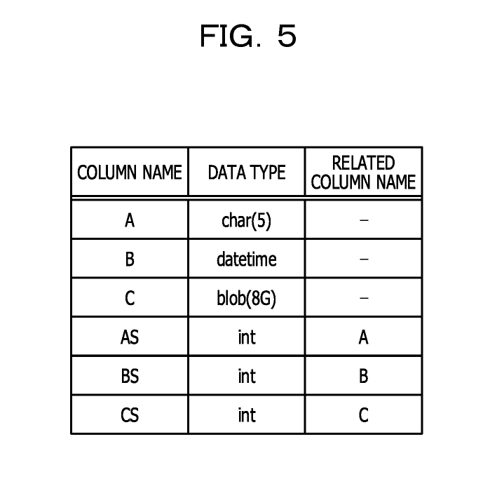

The storage unit 201 stores therein metadata. The metadata includes information relating to the structure of a table. Details will be described later using FIG. 5.

The transmission unit 203 transmits various kinds of data to the application unit 107 in the application device 105. The transmission unit 203 further transmits various kinds of data to the relational database 103 in the relational database device 101.

The reception unit 205 receives various kinds of data from the application unit 107 in the application device 105. The reception unit 205 further receives various kinds of data from the relational database 103 in the relational database device 101.

In response to a request from the application unit 107, the generation instruction unit 207 instructs the relational database 103 to generate a table.

In response to a request from the application unit 107, the addition instruction unit 209 instructs the relational database 103 to add data.

In response to a request from the application unit 107, the update instruction unit 211 instructs the relational database 103 to update data.

In response to a request from the application unit 107, the extraction instruction unit 213 calculates the size of extraction result data. Furthermore, in response to a request from the application unit 107, the extraction instruction unit 213 instructs the relational database 103 to extract data.

The extraction instruction unit 213 includes a first acquisition unit 215, a calculation unit 217, and a second acquisition unit 219. The first acquisition unit 215 acquires the size of data from the relational database 103. The calculation unit 217 calculates the size of the extraction result data. The second acquisition unit 219 acquires data extracted from the relational database 103.

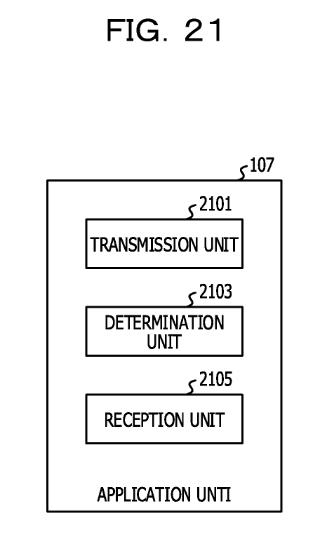

The storage unit 201, the transmission unit 203, the reception unit 205, the generation instruction unit 207, the addition instruction unit 209, the update instruction unit 211, and the extraction instruction unit 213, described above, are realized by, for example, hardware resources illustrated in FIG. 21. In addition, as for the transmission unit 203, the reception unit 205, the generation instruction unit 207, the addition instruction unit 209, the update instruction unit 211, and the extraction instruction unit 213, all or part of processing in the corresponding modules may be realized by sequentially executing, in a CPU 2503 (FIG. 21), programs loaded into a memory 2501 (FIG. 21).

The operation of the database system will be described in order of individual phases illustrated as follows.

(1) In a table generation phase, a new table is generated in the relational database 103 in accordance with a request of the application unit 107. (2) In a data addition or update phase, data is added to or updated in a table in the relational database 103 in accordance with a request of the application unit 107. (3) In a size calculation phase, the size of data to be extracted is calculated in accordance with a request of the application unit 107. (4) In an actual data acquisition phase, data extracted from the relational database 103 is passed to the application unit 107, in accordance with a request of the application unit 107.

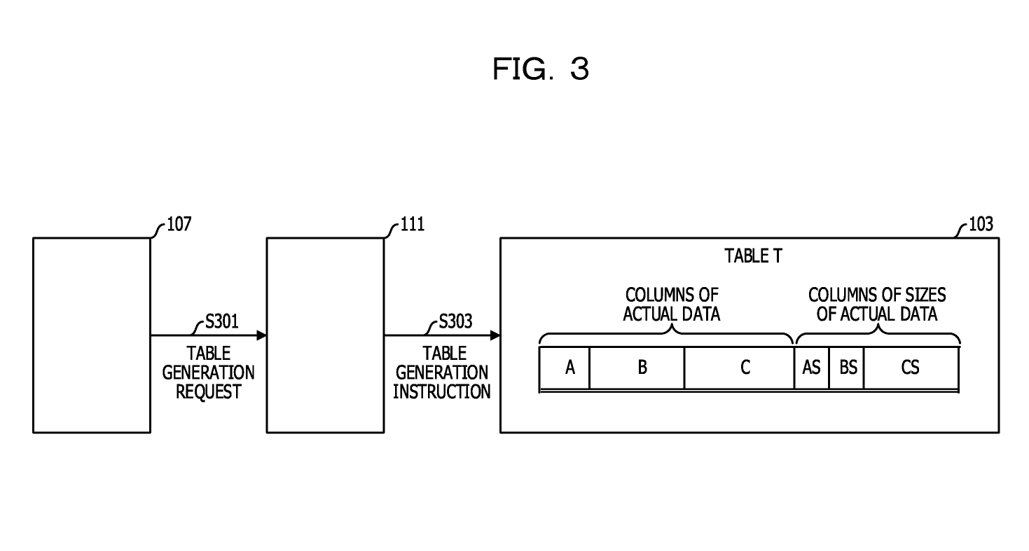

The outline of table generation according to the first embodiment will be described using FIG. 3. The application unit 107 transmits a table generation request to the mediation unit 111 (S301). The table generation request includes a table name. In addition, the table generation request specifies a set of a column name and a data type for each column. The table generation request in this example includes a set of a table name, “T”, a column name, “A”, and a data type, “char(5)”, a set of a column name, “B”, and a data type, “datetime”, and a set of a column name, “C”, and a data type, “blob(8G)”. Texts in parentheses included in the data types indicate data sizes.

In the table generation request, a column pattern may be specified. The column pattern is the combination of columns from which pieces of data are simultaneously extracted.

The number of the combinations of columns may be one, or two or more. In this example, columns delimited by “,” form one combination. In addition, in a case where a plurality of combinations of columns are specified, the combinations of columns are delimited by “/”. For example, in a case where the column pattern is specified in such a manner as “A/A,B/A,C”, it may be assumed that data is extracted from a column of the column name, “A”, (hereinafter called a column A), data from the column A and data from a column of the column name, “B”, (hereinafter called a column B) are extracted in combination, or data from the column A and data from a column of the column name, “C”, (hereinafter called a column C) are extracted in combination.

In addition, in a case where, for example, a column pattern, “A,B,C”, is specified, it may be assumed that data from the column A, data from the column B, and data from the column C are extracted in combination.

In a case where the column pattern is not specified, it may be assumed that data is extracted from the column A, data is extracted from the column B, or data is extracted from the column C.

In response to that request, the mediation unit 111 generates and transmits a table generation instruction (CREATE TABLE), to the relational database 103 (S303). In a case where, for example, the column pattern is not specified, such a table generation instruction as “create table T (A char(5), B datetime, C blob(8G), AS int, BS int, CS int)” is generated.

This table generation instruction includes the following contents. A table of the table name, “T”, is generated. A column whose column name is “A” and whose data type is “char(5)” is generated. A column whose column name is “B” and whose data type is “datetime” is generated. A column whose column name is “C” and whose data type is “blob(8G)” is generated. A column whose column name is “AS” and whose data type is “int” is generated. A column whose column name is “BS” and whose data type is “int” is generated. A column whose column name is “CS” and whose data type is “int” is generated.

Hereinafter, a column whose column name is “AS” is called a column AS. A column whose column name is “BS” is called a column BS. In addition, a column whose column name is “CS” is called a column CS.

In accordance with the above-mentioned table generation instruction, a table T is generated in the relational database 103 as illustrated in the drawing. The column A, the column B, and the column C out of the above-mentioned columns are columns for storing therein pieces of actual data. On the other hand, the column AS, the column BS, and the column CS are columns for storing therein pieces of size data. In the column AS, a value indicating the size of the actual data stored in the column A is stored. In the column BS, a value indicating the size of the actual data stored in the column B is stored. In the column CS, a value indicating the size of the actual data stored in the column C is stored. The column AS, the column BS, and the column CS are columns added by the mediation unit 111. In addition, the pieces of actual data are various kinds of data the application unit 107 causes the relational database 103 to store therein or various kinds of data the application unit 107 acquires from the relational database 103 and uses.

For example, in a case where a column pattern, “A,B”, is specified, such a table generation instruction as “create table T (A char(5), B datetime, C blob(8G), ABS int)” is generated. In a column ABS, a value indicating the total size of the size of the actual data stored in the column A and the size of the actual data stored in the column B is stored.

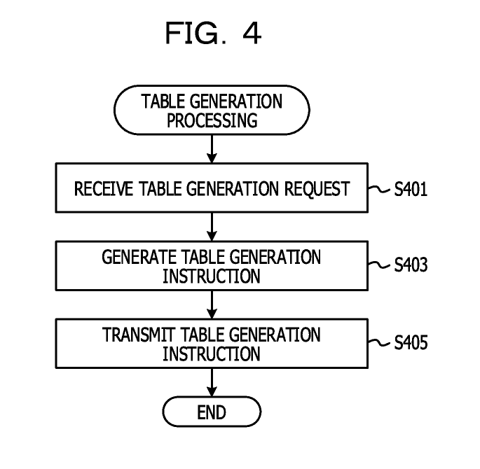

Subsequently, processing in the mediation unit 111 in table generation will be described. FIG. 4 illustrates the flow of table generation processing. In a case where the reception unit 205 receives the table generation request as illustrated in S301 in FIG. 3 (S401), the generation instruction unit 207 generates a table generation instruction in response to the table generation request (S403).

At this time, the generation instruction unit 207 causes a table name (for example, “T”) included in the table generation request to be included in the table generation instruction without change. In addition, the generation instruction unit 207 causes a column name (for example, “A”) and a data type (for example, “char(5)”) included in the table generation request to be included in the table generation instruction without change. Furthermore, the generation instruction unit 207 generates a size column name (for example, “AS”) corresponding to the column name (for example, “A”) included in the table generation request, and adds the size column name and the data type, “int”, to the table generation instruction. In this example, by adding “S” to the column name of a column for storing therein actual data, the column name (called a size column name) of a column (called a size column) for storing therein the size value of data to be stored in the corresponding column is defined.

At this time, the reception unit 205 generates metadata. FIG. 5 illustrates an example of metadata. The metadata includes records corresponding to respective columns. The records each include a field for setting a column name, a field for setting a data type, and a field for setting a related column name. The related column name is used in a case where the corresponding record is related to the size column. The related column name is the name of a column in which actual data serving as a source of that size is stored.

FIG. 5 illustrates metadata in the table T. A first record indicates that the column name of a first column in the table T is “A” and the data type of the first column is “char(5)”. Since this column is not the size column, the related column name is not set.

A second record indicates that the column name of a second column in the table T is “B” and the data type of the second column is “datetime”. Since this column is not the size column, the related column name is not set.

A third record indicates that the column name of a third column in the table T is “C” and the data type of the third column is “blob(8G)”. Since this column is not the size column, the related column name is not set.

A fourth record indicates that the column name of a fourth column in the table T is “AS” and the data type of the fourth column is “int”. In addition, the fourth record indicates that the fourth column stores therein the size value of data stored in the column A identified by the related column name, “A”.

A fifth record indicates that the column name of a fifth column in the table T is “BS” and the data type of the fifth column is “int”. In addition, the fifth record indicates that the fifth column stores therein the size value of data stored in the column B identified by the related column name, “B”.

A sixth record indicates that the column name of a sixth column in the table T is “CS” and the data type of the sixth column is “int”. In addition, the sixth record indicates that the sixth column stores therein the size value of data stored in the column C identified by the related column name, “C”.

The transmission unit 203 transmits the table generation instruction to the relational database 103 as illustrated in S303 in FIG. 3 (S405).

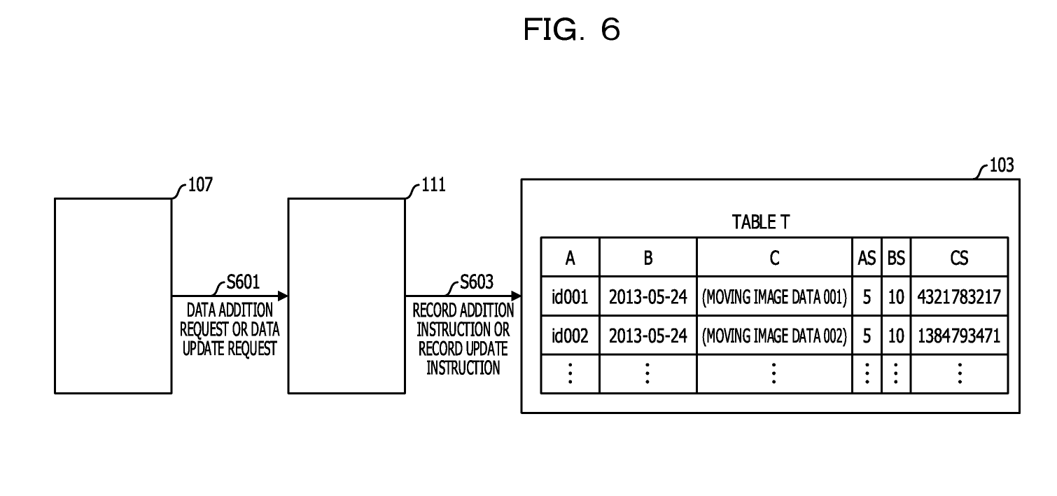

Subsequently, FIG. 6 illustrates the outlines of data addition and data update according to the first embodiment. The application unit 107 transmits a data addition request or a data update request to the mediation unit 111 (S601). The data addition request specifies a set of a column name and actual data. The data addition request in this example includes a set of the column name, “A”, and actual data, ‘id001’, a set of the column name, “B”, and actual data, ‘2013-05-24’, and a set of the column name, “C”, and the identification information of moving image data. The moving image data is attached to the data addition request.

The data update request specifies a set of a column name and actual data in the same way as the data addition request. In a case of the data update request, data for identifying a record to serve as an update target is included.

In response to the data addition request, the mediation unit 111 generates and transmits a record addition instruction (INSERT), to the relational database 103 (S603). Alternatively, in response to the data update request, the mediation unit 111 generates and transmits a record update instruction (UPDATE), to the relational database 103 (S603).

At this time, with reference to metadata concerning the corresponding table, the mediation unit 111 stores, in a corresponding size column, the size value of actual data to be registered. In this regard, however, in a case where no size column is set for a column serving as a registration destination, the storage of the size value is not performed.

In this example, since a size column is set for each of the column A, the column B, and the column C, actual data is stored and a size value is stored therein. Therefore, such a data addition instruction as “insert into T (A,B,C,AS,BS,CS) values (‘id001’,‘2013-05-24’,?,5,10,4321783217)” is generated. In the above-mentioned “?” portion within the parameter, an input stream of moving image data is set.

This data addition instruction includes the following contents. A record is added to the table of the table name, “T”. The actual data, ‘id001’, is set in the column A. The actual data, ‘2013-05-24’, is set in the column B. The moving image data is set in the column C. In this regard, however, actually the moving image data is saved outside of the table, and information for leading to the moving image data is stored in the column C. The size value of 5 is set in the column AS. The size value of 10 is set in the column BS. The size value of 4321783217 is set in the column CS.

As illustrated in the drawing, a new record is added to the table T in the relational database 103. A first record is an example of addition by the above-mentioned data addition instruction. A second record indicates an example generated as a result of transmitting the moving image data while attaching the moving image data to such a data addition instruction as “insert into T (A,B,C,AS,BS,CS) values (‘id002’,‘2013-05-24’,?,5,10,1384793471)”.

In addition, in a case of transmitting the data update instruction, new data is set in an existing record. Specifically, actual data is rewritten, and a size value is rewritten.

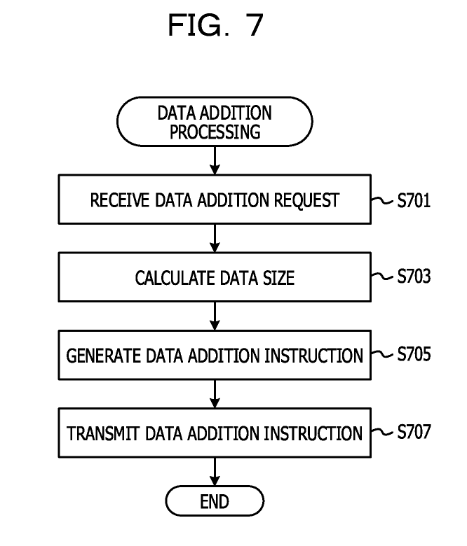

FIG. 7 illustrates the flow of data addition processing. In a case where the reception unit 205 receives the data addition request as illustrated in S601 in FIG. 6 (S701), the addition instruction unit 209 calculates the size of actual data to be added (S703). If the actual data is, for example, ‘id001’, a size value is 5 bytes. In addition, if the actual data is ‘2013-05-24’, a size value is 10 bytes. The size value of moving image data is measured from moving image data serving as a source.

The addition instruction unit 209 generates the above-mentioned data addition instruction (S705). At this time, the addition instruction unit 209 causes a column name (for example, “A”) and actual data (for example, ‘id001’) included in the data addition request to be included in the data addition instruction without change. Furthermore, the addition instruction unit 209 causes a size column (for example, “AS”) corresponding to a column included in the data addition request and the size value (for example, “5”) calculated in S703 to be included in the data addition instruction.

The transmission unit 203 transmits the data addition instruction to the relational database 103 as illustrated in S603 in FIG. 6 (S707).

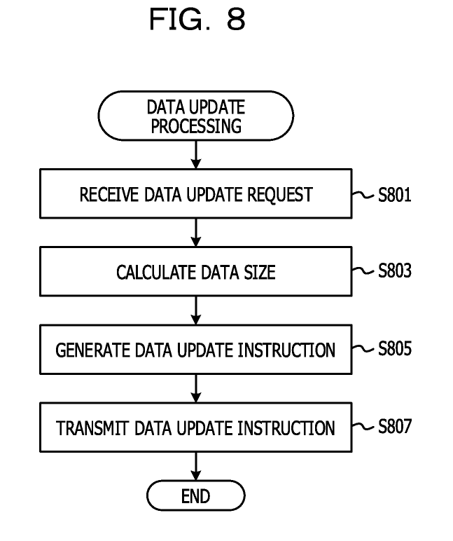

FIG. 8 illustrates the flow of data update processing. In a case where the reception unit 205 receives the data update request as illustrated in S601 in FIG. 6 (S801), the update instruction unit 211 calculates the size value of actual data to be newly written (S803). The size value of actual data is calculated in the same way as in the case of S703 in FIG. 7.

The update instruction unit 211 generates a data update instruction (S805). At this time, the update instruction unit 211 causes a column name and actual data included in the data update request to be included in the data update instruction without change. Furthermore, the update instruction unit 211 causes a size column corresponding to the column included in the data update request and the size value calculated in S803 to be included in the data update instruction.

The transmission unit 203 transmits the data update instruction to the relational database 103, as illustrated in S603 in FIG. 6 (S807).

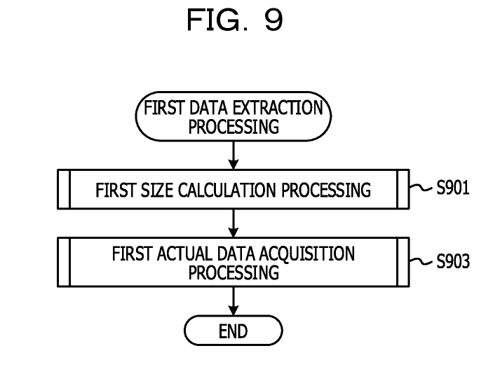

Subsequently, a procedure where the application unit 107 extracts data from the relational database 103 will be described. This procedure includes the size calculation phase and the actual data acquisition phase. Therefore, as illustrated in FIG. 9, in first data extraction processing, after the calculation unit 217 in the extraction instruction unit 213 executes first size calculation processing (S901), the second acquisition unit 219 in the extraction instruction unit 213 executes first actual data acquisition processing (S903).

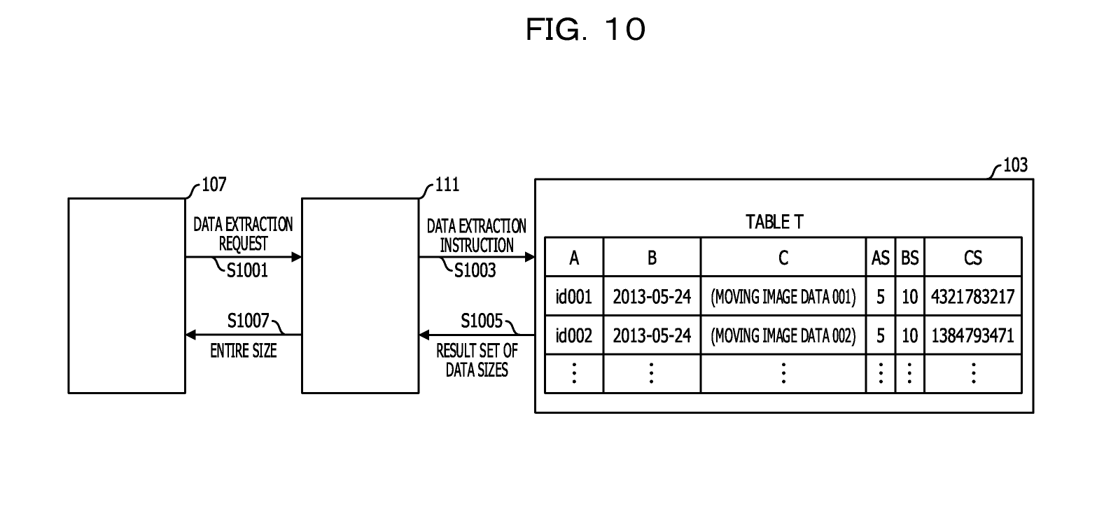

First, the size calculation phase will be described. FIG. 10 illustrates the outline of size calculation according to the first embodiment. The application unit 107 transmits a data extraction request to the mediation unit 111 (S1001). As described above, the data extraction request includes an extraction condition and an output item.

Hereinafter, a first example including the column names, “A” and “C”, as the output item and a second example including the column names, “A” and “B”, as the output item will be described. In addition, in each of the first example and the second example, the extraction condition is “A=id001”. In other words, a record where the value of the column A is ‘id001’ is regarded as a target of data extraction.

Based on metadata, the mediation unit 111 determines whether or not a size column corresponding to actual data is set. In a case of determining that the size column corresponding to actual data is set, the mediation unit 111 generates a data extraction instruction (SELECT) for acquiring a size value from the size column, and transmits the data extraction instruction (SELECT) to the relational database 103 (S1003). In a case of determining that the size column corresponding to actual data is not set, processing for acquiring a data value is not performed.

In a case of the first example, it is determined whether or not the size column AS including “A” as the related column name is set and the size column CS including “C” as the related column name is further set. In a case where both the size column AS and the size column CS are set, size values are extracted from the respective size columns. At this time, such a data extraction instruction as “SELECT AS,CS FROM T WHERE A=id001” is generated.

In the case of the second example, it is determined whether or not the size column AS including “A” as the related column name is set and the size column BS including “B” as the related column name is further set. In a case where both the size column AS and the size column BS are set, size values are extracted from the respective size columns. Such a data extraction instruction as “SELECT AS,BS FROM T WHERE A=id001” is generated.

In addition, in a case where, for example, the column names, “A” and “C”, are included in the data extraction request, it may be further determined whether or not a size column ACS including “A,C” as the related column name is set. In a case where the size column ACS is set, size values are extracted from the respective size columns. Such a data extraction instruction as “SELECT ACS FROM T WHERE A=id001” is generated. At this time, the obtained size value is treated as the sum of the size value of data extracted from the column A and the size value of data extracted from the column C.

The relational database 103 transmits a result set of the data sizes to the mediation unit 111 (S1005). The mediation unit 111 calculates the sum of the data sizes, and transmits the result thereof to the application unit 107 (S1007).

In the case of, for example, the first example, since the size value acquired from the size column AS is 5 and the size value acquired from the size column CS is 4321783217, the sum of the data sizes is 4321783222.

In the case of, for example, the second example, since the size value acquired from the size column AS is 5 and the size value acquired from the size column BS is 10, the sum of the data sizes is 15.

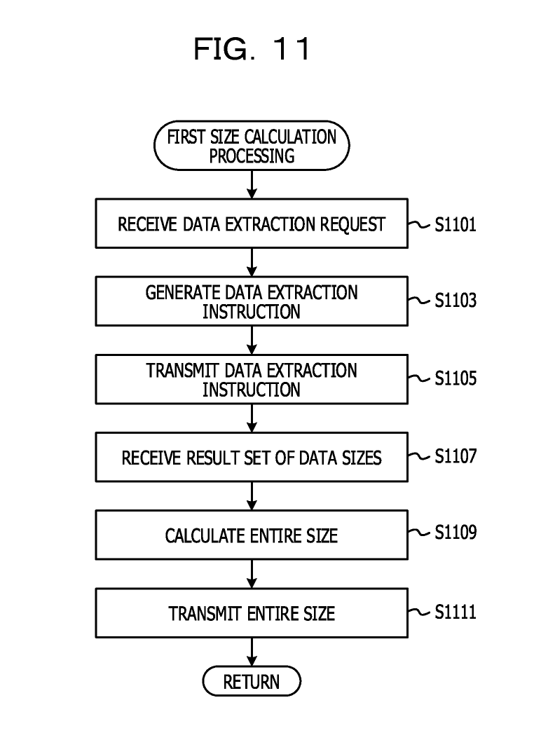

FIG. 11 illustrates the flow of the first size calculation processing. In a case where the reception unit 205 receives the data extraction request as illustrated in S1001 in FIG. 10 (S1101), the first acquisition unit 215 generates a data extraction instruction (S1103). At this time, based on a column name included in the data extraction request, the first acquisition unit 215 identifies a size column name. In this example, by adding “S” to the column name, the first acquisition unit 215 identifies the size column name. Alternatively, the first acquisition unit 215 searches for a related column name matching the column name of actual data, in metadata, and identifies the size column name.

Through the transmission unit 203 as illustrated in S1003 in FIG. 10, the first acquisition unit 215 transmits the data extraction instruction to the relational database 103 (S1105). In a case where the first acquisition unit 215 receives a result set of sizes from the relational database 103 through the reception unit 205 as illustrated in S1005 in FIG. 10 (S1107), the calculation unit 217 calculates an entire size by summating the size values of respective columns (S1109). In a case where size values are acquired for a plurality of records, the first acquisition unit 215 summates size values according to respective records. The transmission unit 203 transmits the entire size as illustrated in S1007 in FIG. 10 (S1111). This is the end of the description of the data calculation phase.

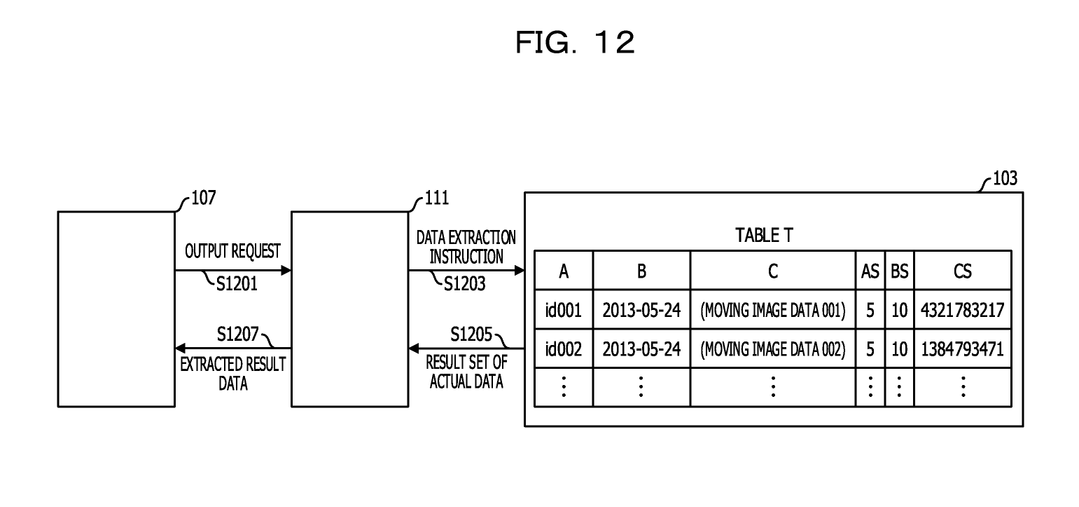

Next, the actual data acquisition phase will be described. FIG. 12 illustrates the outline of actual data acquisition according to the first embodiment. In a case where the application unit 107 receives the entire size, whether or not to continue processing is determined on an application device 105 side.

For example, the application unit 107 causes a display device in the application device 105 to display the entire size, and prompts a user to determine whether or not to continue processing. In addition, in accordance with an instruction of the user, received through an input device in the application device 105, the application unit 107 identifies whether or not to continue processing.

Alternatively, in a case where the received total size exceeds a predetermined threshold value, the application device 105 may determine not to continue processing. In addition, in a case where the received total size does not exceed the predetermined threshold value, the application device 105 may determine to continue processing. An example where the application device 105 determines whether or not to continue processing will be described later in detail in the after-mentioned embodiment.

In a case of determining to continue processing, the application unit 107 transmits an output request to the mediation unit 111 (S1201). In a case of determining not to continue processing, the processing is terminated at that time.

Upon receiving the output request, the mediation unit 111 generates and transmits a data extraction instruction (SELECT), to the relational database 103 (S1203). For example, such a data extraction instruction as “SELECT A,B FROM T WHERE A=id001” is generated.

The relational database 103 transmits a result set of actual data to the mediation unit 111 (S1205). The result set of actual data includes, for example, such data as “A,id001/B,2013-05-24”.

The mediation unit 111 acquires actual data from the result set of actual data, changes the actual data to a predetermined format, and transmits the actual data to the application unit 107 (S1207). At this time, the result set of actual data may be transmitted to the application unit 107 without change.

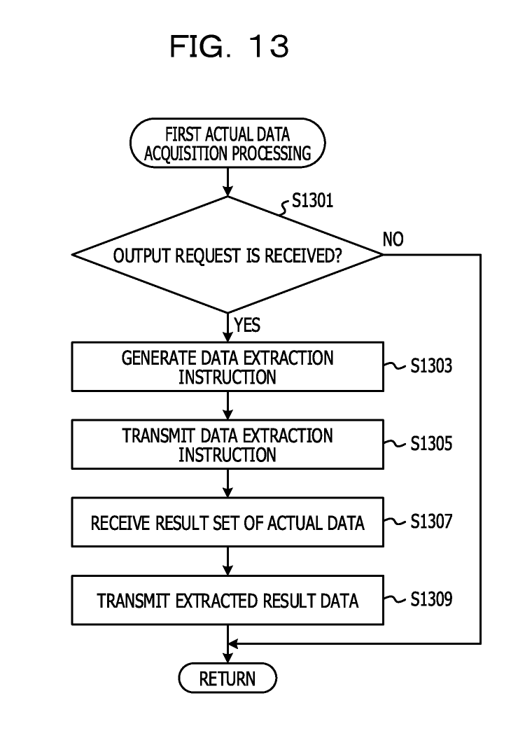

FIG. 13 illustrates the flow of the first actual data acquisition processing. Based on whether or not the reception unit 205 receives the output request, the extraction instruction unit 213 branches processing (S1301).

In a case where the reception unit 205 does not receive the output request within a predetermined time period, the processing in FIG. 13 is terminated, processing returns to the processing in FIG. 9, and the first data extraction processing is terminated.

In a case where the reception unit 205 receives the output request, the second acquisition unit 219 generates a data extraction instruction, based on the data extraction request received in S1001 in FIG. 10 (S1303).

The transmission unit 203 transmits the data extraction instruction to the relational database 103 (S1305). The reception unit 205 receives a result set of actual data from the relational database 103 (S1307).

The transmission unit 203 transmits extraction result data to the application unit 107 (S1309). The extraction result data may be data obtained by changing actual data extracted from the result set to a predetermined format or may be the result set itself.

According to the present embodiment, it is possible to preliminarily identify a data amount extracted, based on a query, from the relational database 103. Accordingly, it is easy to predict time taken to transmit search result data. In addition, it is easy to predict interruption of data transmission.

In addition, it is possible to identify data sizes for various queries. There is an aspect of not wastefully using resources such as a CPU and a memory.

In addition, it becomes possible to selectively transmit actual data. In a case where, for example, the entire size is large, it is possible to stop data transmission.

### Second Embodiment

While, in the above-mentioned embodiment, an example where the same table includes the actual data column and the size column has been described, an example where the size column is provided in a table different from a table including the actual data column will be described in the present embodiment.

In the present embodiment, a method for setting a size value for actual data in an already existing table is provided.

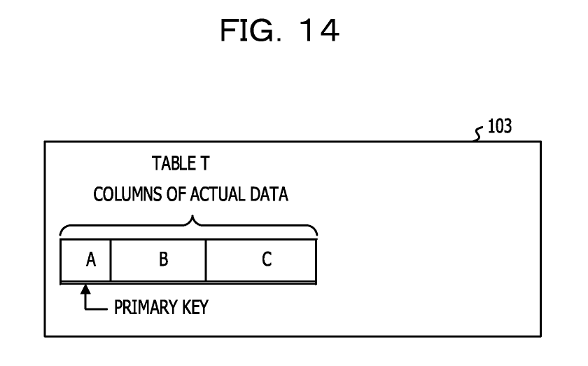

FIG. 14 illustrates an example of a table according to the second embodiment. As illustrated in the drawing, a table T is held in the relational database 103. A column A, a column B, and a column C are columns for storing therein pieces of actual data. In the same way as in the above-mentioned embodiment, the pieces of actual data are various kinds of data the application unit 107 causes the relational database 103 to store therein or various kinds of data the application unit 107 acquires from the relational database 103 and uses. In this example, the column A is a primary key.

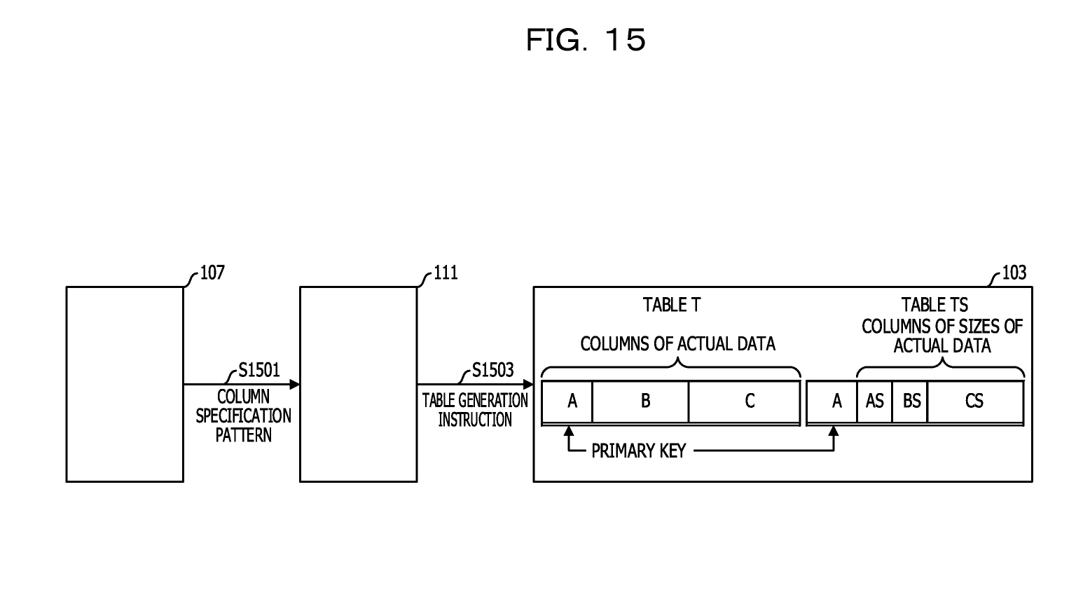

Next, using FIG. 15, the outline of table generation according to the second embodiment will be described. The application unit 107 sends a column pattern to the mediation unit 111 (S1501). In the same way as in the first embodiment, the column pattern is the combination of columns from which pieces of data are simultaneously extracted.

In the same way as in the above-mentioned embodiment, the number of the combinations of columns may be one, or two or more. In this example, columns delimited by “,” form one combination. In addition, in a case where a plurality of combinations of columns are specified, the combinations of columns are delimited by “/”. For example, in a case where the column pattern is specified in such a manner as “T-A/T-B/T-C”, it may be assumed that data is extracted from a column of the column name, “A”, in the table T (hereinafter called the column A), data is extracted from a column of the column name, “B”, in the table T (hereinafter called the column B), or data is extracted from a column of the column name, “C”, in the table T (hereinafter called the column C). In addition, in a case where the column pattern is specified in such a manner as “T”, the column pattern is considered to be specified as “T-A/T-B/T-C”.

In response to that request, the mediation unit 111 generates and transmits a table generation instruction (CREATE TABLE), to the relational database 103 (S1503). In a case where, for example, the column pattern is specified as “T-A/T-B/T-C”, such a table generation instruction as “create table TS (A char(5), AS int, BS int, CS int) is generated.

This table generation instruction includes the following contents. A table of the table name, “TS”, is generated. A column whose column name is “A” and whose data type is “char(5)” is generated. A column whose column name is “AS” and whose data type is “int” is generated. A column whose column name is “BS” and whose data type is “int” is generated. A column whose column name is “CS” and whose data type is “int” is generated.

Hereinafter, a column whose column name is “AS” is called a column AS. A column whose column name is “BS” is called a column BS. In addition, a column whose column name is “CS” is called a column CS.

In accordance with the above-mentioned table generation instruction, a table TS is generated in the relational database 103 as illustrated in the drawing. The column A out of the above-mentioned columns is a column for storing therein actual data. On the other hand, the column AS, the column BS, and the column CS are columns for storing therein pieces of size data. In the column A, the same data as that of the column A in the table TS is stored. The column A is the primary key in the table TS.

In the column AS, a value indicating the size of the actual data stored in the column A is stored. In the column BS, a value indicating the size of the actual data stored in the column B is stored. In the column CS, a value indicating the size of the actual data stored in the column C is stored.

Subsequently, using FIG. 4, processing in the mediation unit 111 in table generation will be described. In a case where the reception unit 205 receives the table generation request as illustrated in S1501 in FIG. 15 (S401), the generation instruction unit 207 generates the table generation instruction in response to the table generation request (S403).

At this time, the generation instruction unit 207 identifies a table name to be newly added. In this example, the generation instruction unit 207 adds “S” to an existing table name (for example, “T”), and identifies the table name to be newly added. The generation instruction unit 207 causes that table name to be included in the table generation instruction.

Furthermore, first, the generation instruction unit 207 adds a column name to serve as a primary key and the data type thereof to the table generation instruction. Subsequently, the generation instruction unit 207 generates a size column name (for example, “AS”) corresponding to a column name (for example, “A”) included in the existing table, and adds the size column name and the data type, “int”, to the table generation instruction. In this example, by adding “S” to the column name of a column included in the existing table, the column name (called a size column name) of a column (called a size column) for storing therein the size value of data to be stored in the corresponding column is defined.

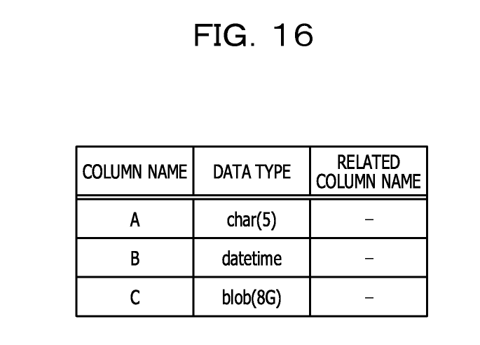

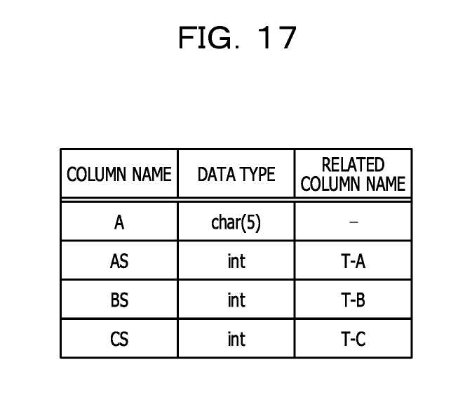

At this time, the generation instruction unit 207 generates metadata. FIG. 16 and FIG. 17 illustrate examples of metadata. In the same way as in the above-mentioned embodiment, the metadata includes records corresponding to respective columns. The records each include a field for setting a column name, a field for setting a data type, and a field for setting a related column name. The related column name is used in a case where the corresponding record is related to the size column. The related column name is the name of a column in which actual data serving as a source of that size is stored.

FIG. 16 illustrates metadata concerning the existing table T. A first record indicates that the column name of a first column in the table T is “A” and the data type of the first column is “char(5)”. Since this column is not the size column, the related column name is not set.

A second record indicates that the column name of a second column in the table T is “B” and the data type of the second column is “datetime”. Since this column is not the size column, the related column name is not set.

A third record indicates that the column name of a third column in the table T is “C” and the data type of the third column is “blob(8G)”. Since this column is not the size column, the related column name is not set.

FIG. 17 illustrates an example of metadata concerning the added table TS. A first record indicates that the column name of a first column in the table TS is “A” and the data type of the first column is “char(5)”. Since this column is not the size column, the related column name is not set.

A second record indicates that the column name of a second column in the table TS is “AS” and the data type of the second column is “int”. In addition, the second record indicates that the second column stores therein the size value of data stored in the column A in the table T, identified by the related column name, “T-A”.

A third record indicates that the column name of a third column in the table TS is “BS” and the data type of the third column is “int”. In addition, the third record indicates that the third column stores therein the size value of data stored in the column B in the table T, identified by the related column name, “T-B”.

A fourth record indicates that the column name of a fourth column in the table TS is “CS” and the data type of the fourth column is “int”. In addition, the fourth record indicates that the fourth column stores therein the size value of data stored in the column C in the table T, identified by the related column name, “T-C”.

The transmission unit 203 transmits the table generation instruction to the relational database 103 as illustrated in S1503 in FIG. 15 (S405).

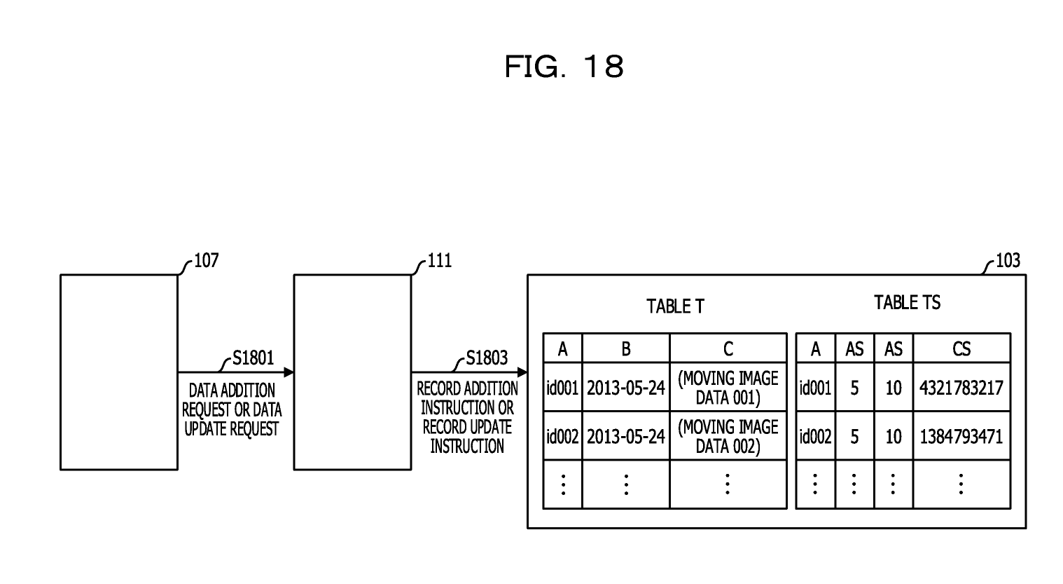

Subsequently, FIG. 18 illustrates the outlines of data addition and data update according to the second embodiment. The application unit 107 transmits a data addition request or a data update request to the mediation unit 111 (S1801). The data addition request specifies a set of a column name and actual data. The data addition request in this example includes a set of the column name, “A”, and actual data, ‘id001’, a set of the column name, “B”, and actual data, ‘2013-05-24’, and a set of the column name, “C”, and the identification information of moving image data. The moving image data is attached to the data addition request.

In the same way as in the above-mentioned embodiment, the data update request specifies a set of a column name and actual data in the same way as the data addition request. In a case of the data update request, data for identifying a record to serve as an update target is included.

In the same way as in the above-mentioned embodiment, in response to the data addition request, the mediation unit 111 generates and transmits a record addition instruction (INSERT), to the relational database 103 (S1803). Alternatively, in response to the data update request, the mediation unit 111 generates and transmits a record update instruction (UPDATE), to the relational database 103 (S1803).

In the same way as in the above-mentioned embodiment, at this time, with reference to metadata concerning the corresponding table, the mediation unit 111 stores, in a corresponding size column, the size value of actual data to be registered. In this regard, however, in a case where no size column is set for a column in which the actual data is to be registered, the storage of the size value is not performed.

In the same way as in the above-mentioned embodiment, since a size column is set for each of the column A, the column B, and the column C, actual data is stored and a size value is stored therein. Therefore, two data addition instructions are generated. First, such a data addition instruction as “insert into T (A,B,C) values (‘id001’,‘2013-05-024’,?)” is generated. In the above-mentioned “?” portion within the parameter, an input stream of moving image data is set.

This data addition instruction includes the following contents. A record is added to the table of the table name, “T”. Actual data, ‘id001’, is set in the column A. Actual data, ‘2013-05-24’, is set in the column B. The moving image data is set in the column C. In this regard, however, actually the moving image data is saved outside of the table, and information for leading to the moving image data is stored in the column C.

Furthermore, such a data addition instruction as “insert into TS (A,AS,BS,CS) values (‘id001’,5,10,4321783217)” is generated.

This data addition instruction includes the following contents. A record is added to the table of the table name, “TS”. Actual data, ‘id001’, is set in the column A. The size value of 5 is set in the column AS. The size value of 10 is set in the column BS. The size value of 4321783217 is set in the column CS.

As illustrated in the drawing, a new record is added to the table T in the relational database 103. A first record is added by the above-mentioned first data addition instruction. Furthermore, a new record is added to the table TS in the relational database 103. A first record is added by the above-mentioned second data addition instruction.

In addition, in a case of transmitting the data update instruction, new data is set in an existing record. Specifically, actual data is rewritten, and a size value is rewritten.

In S705 within the flow of the data addition processing illustrated in FIG. 7, the addition instruction unit 209 generates the two data addition instructions as described above. At this time, the addition instruction unit 209 causes a column name and actual data included in the data addition request to be included in the first data addition instruction without change. Furthermore, the addition instruction unit 209 causes a size column corresponding to the column included in the data addition request and the size value calculated in S703 to be included in the second data addition instruction. In addition, in a case where the column name included in the data addition request is “A”, the column name and the actual data are caused to be included in the second data addition instruction. The reason is to maintain a relationship between the table T and the table TS.

The transmission unit 203 transmits the two data addition instructions to the relational database 103 (S707).

In addition, in S805 within the flow of the data update processing illustrated in FIG. 8, the update instruction unit 211 generates two data update instructions as described above. At this time, the update instruction unit 211 causes a column name and actual data included in the data update request to be included in the first data update instruction without change. Furthermore, the update instruction unit 211 causes a size column corresponding to the column included in the data update request and the size value calculated in S803 to be included in the second data update instruction. In addition, in a case where the column name included in the data update request is “A”, the column name and the actual data are caused to be included in the second data update instruction.

The transmission unit 203 transmits the two data update instructions to the relational database 103 (S807).

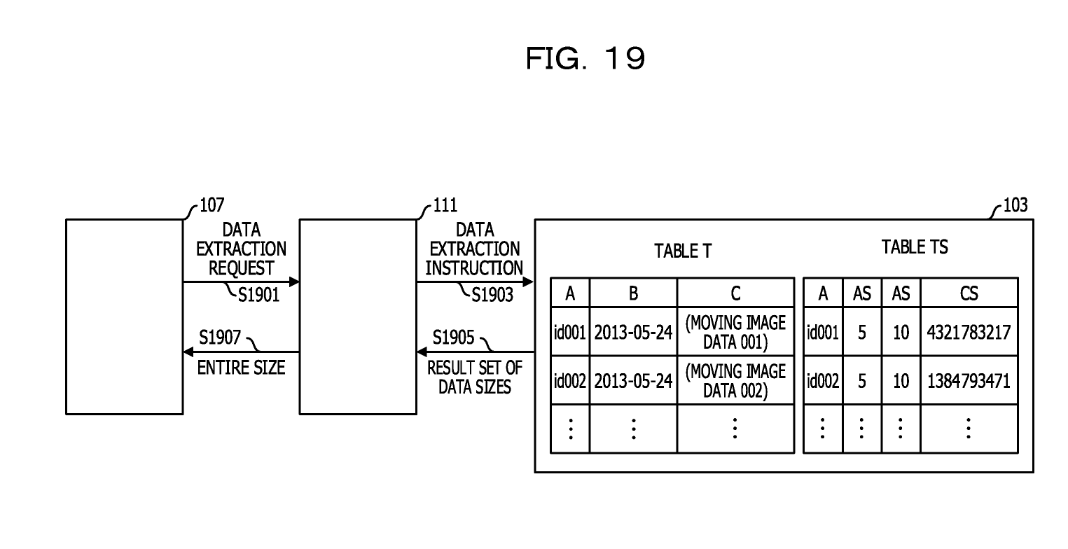

Subsequently, FIG. 19 illustrates the outline of size calculation according to the second embodiment. In the same way as in S1001 in FIG. 10, the application unit 107 transmits a data extraction request to the mediation unit 111 (S1901). As described above, the data extraction request includes an extraction condition and an output item.

In the same way as in the above-mentioned embodiment, based on metadata, the mediation unit 111 determines whether or not a size column corresponding to actual data is set. In a case of determining that the size column corresponding to actual data is set, the mediation unit 111 generates a data extraction instruction (SELECT) for acquiring a size value from the size column, and transmits the data extraction instruction (SELECT) to the relational database 103, in the same way as in S1001 in FIG. 10 (S1903).

In the same way as in the above-mentioned embodiment, the relational database 103 transmits a result set of the data sizes to the mediation unit 111 (S1905). The mediation unit 111 calculates the sum of the data sizes, and transmits the result thereof to the application unit 107 (S1907).

In S1103 within the flow of the first size calculation processing illustrated in FIG. 11, a data extraction instruction for acquiring a size value from the size column in the table TS is generated. In a case of, for example, the first example illustrated in the above-mentioned embodiment, such a data extraction instruction as “SELECT AS,CS FROM TS WHERE A=id001” is generated. In a case of, for example, the second example illustrated in the above-mentioned embodiment, such a data extraction instruction as “SELECT AS,BS FROM TS WHERE A=id001” is generated. The other processing operations are the same as in the case of the above-mentioned embodiment.

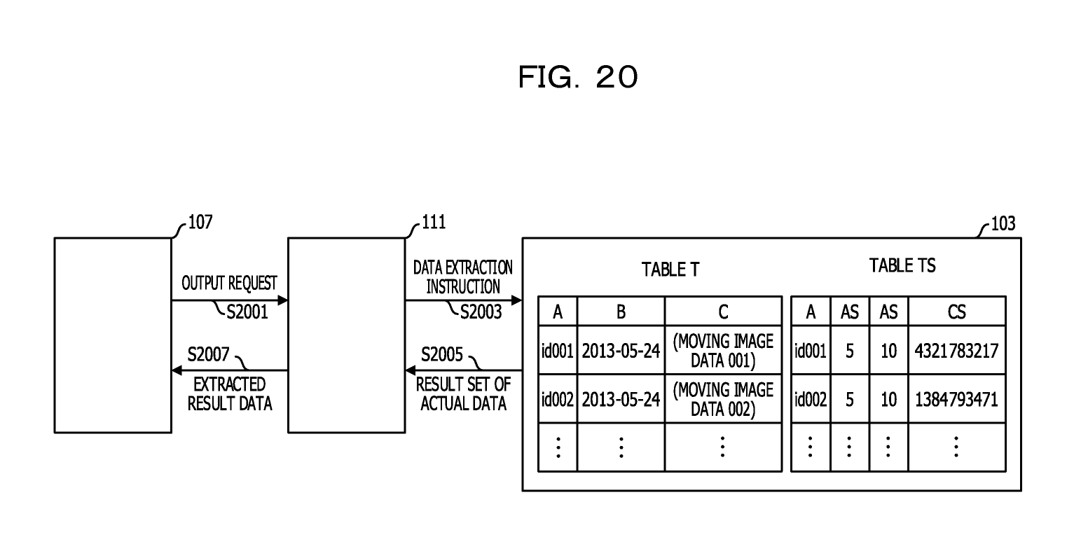

FIG. 20 illustrates the outline of actual data acquisition according to the second embodiment. In the same way as in the above-mentioned embodiment, the application unit 107 transmits an output request to the mediation unit 111 (S2001).

In the same way as in the above-mentioned embodiment, the mediation unit 111 generates and transmits a data extraction instruction (SELECT) for acquiring actual data, to the relational database 103 (S2003).

In the same way as in the above-mentioned embodiment, the relational database 103 transmits a result set of actual data to the mediation unit 111 (S2005). The mediation unit 111 generates and transmits extraction result data, to the application unit 107 (S2007).

The first actual data acquisition processing is the same as in the case of the above-mentioned embodiment (FIG. 13).

According to the present embodiment, it is possible to provide the size column while not altering the table including the column of actual data. For example, it becomes possible to add size data to a currently operated database.

### Third Embodiment

In the present embodiment, an example where, in the application unit 107 in the application device 105, the desirability of continuing processing is determined based on a total size will be described.

FIG. 21 illustrates an example of the module configuration of the application unit 107. The application unit 107 includes a transmission unit 2101, a determination unit 2103, and a reception unit 2105. The transmission unit 2101 transmits various kinds of data to the mediation unit 111 in the mediation device 109. Based on an entire size, the determination unit 2103 determines the desirability of continuing processing. The reception unit 2105 receives various kinds of data from the mediation unit 111 in the mediation device 109.

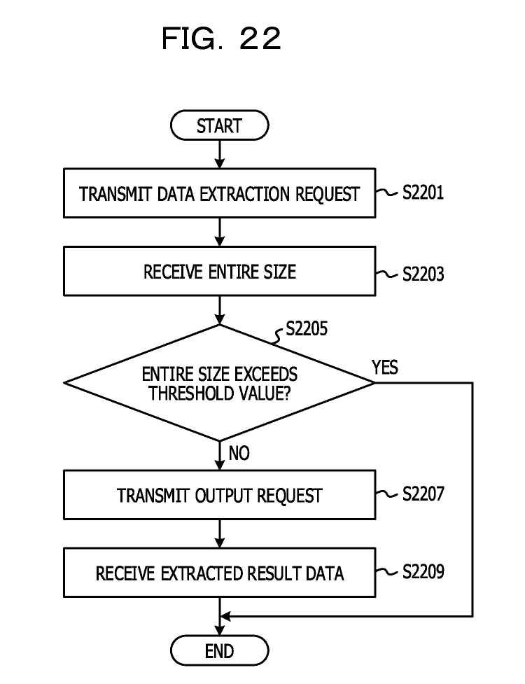

FIG. 22 illustrates the flow of processing by the application unit 107. As illustrated in S1001 in FIG. 10 or S1901 in FIG. 19, the transmission unit 2101 transmits the data extraction request to the mediation unit 111 in the mediation device 109 (S2201). As illustrated in S1007 in FIG. 10 or S1907 in FIG. 19, the transmission unit 2101 receives the entire size from the mediation unit 111 in the mediation device 109 (S2203).

The determination unit 2103 determines whether or not the received entire size exceeds a threshold value (S2205). In a case of determining that the received entire size does not exceed the threshold value, the determination unit 2103 causes processing to be continued.

As illustrated in S1201 in FIG. 12 or S2001 in FIG. 20, the transmission unit 2101 transmits the output request to the mediation unit 111 in the mediation device 109 (S2207). As illustrated in S1207 in FIG. 12 or S2007 in FIG. 20, the reception unit 2105 receives the extraction result data from the mediation unit 111 in the mediation device 109 (S2209).

On the other hand, in a case where, in S2205, it is determined that the received entire size exceeds the threshold value, the application unit 107 causes the processing to be terminated. In other words, the transmission processing of the output request by the transmission unit 2101 (S2207) and the reception processing of the extraction result data by the reception unit 2105 (S2209) are not performed, and the processing is terminated.

The threshold value indicates, for example, a data amount able to be output from the relational database 103. Alternatively, the threshold value may be defied based on the data amount able to be output from the relational database 103. In other words, the determination unit 2103 determines availability of outputting of data from the relational database 103.

The threshold value may be defined in accordance with performance the application unit 107 is desired to have. For example, in a case where processing in the application unit 107 is performed at high speed, the threshold value may be set to a small value, and in a case where processing in the application unit 107 is allowed to be performed at low speed, the threshold value may be set to a large value.

The threshold value may be defined in accordance with the characteristic of data the application unit 107 handles. For example, in a case where there is a characteristic that it is highly likely that no accurate data is included if en entire data size is large, the threshold value may be set to a small value. In addition, in a case where there is a characteristic that it is highly likely that accurate data is included even if the entire data size is large, the threshold value may be set to a large value.

The threshold value may be defined in accordance with the characteristic of a network. For example, in a case where the transmission rate of a network for connecting the application device 105 and the mediation device 109 to each other is high, the threshold value may be set to a large value. In addition, in a case where the transmission rate of the network for connecting the application device 105 and the mediation device 109 to each other is low, the threshold value may be set to a small value.

In this way, a threshold value different depending on the application device 105 utilizing the mediation device 109, or the application unit 107 may be used.

By doing this, it becomes possible to automatically determine whether or not to request extraction result data, based on a data amount able to be output from the relational database 103, the characteristic of the application device 105, the characteristic of the application unit 107, or the like.

### Fourth Embodiment

While, in the third embodiment, an example where whether to continue processing is determined on the application device 105 side has been described, an example where whether to continue processing is determined on a mediation device 109 side will be described in the present embodiment.

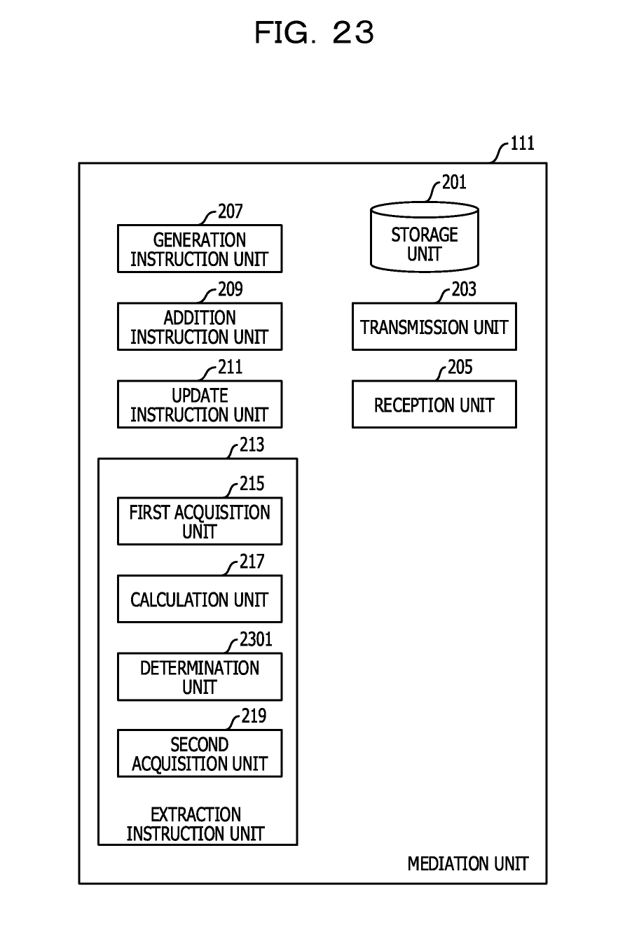

FIG. 23 illustrates an example of the module configuration of the mediation unit 111 according to the fourth embodiment. In the same way as in FIG. 2, the mediation unit 111 includes the storage unit 201, the transmission unit 203, the reception unit 205, the generation instruction unit 207, the addition instruction unit 209, the update instruction unit 211, and the extraction instruction unit 213.

The extraction instruction unit 213 includes a determination unit 2301 in addition to the first acquisition unit 215, the calculation unit 217, and the second acquisition unit 219. The first acquisition unit 215, the calculation unit 217, and the second acquisition unit 219 are the same as those in FIG. 2. The determination unit 2301 determines availability of outputting concerning result data.

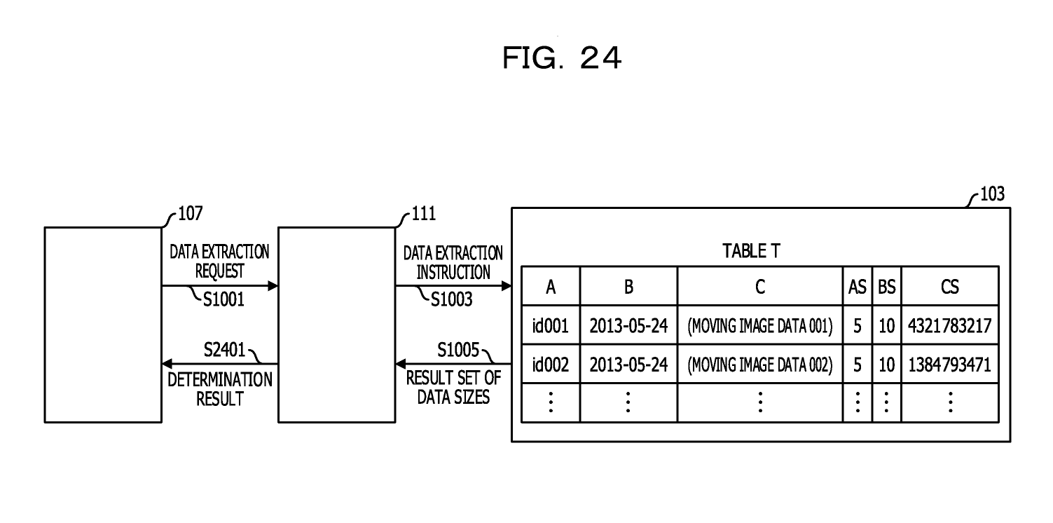

FIG. 24 illustrates the outline of determination of availability of outputting according to the fourth embodiment. FIG. 24 is based on the above-mentioned example of FIG. 10. The application unit 107 transmits a data extraction request to the mediation unit 111 (S1001). This processing operation is the same as that in the case of FIG. 10.

Based on metadata, the mediation unit 111 determines whether or not a size column corresponding to actual data is set. In a case of determining that the size column corresponding to actual data is set, the mediation unit 111 generates a data extraction instruction (SELECT) for acquiring a size value from the size column, and transmits the data extraction instruction (SELECT) to the relational database 103 (S1003). In a case of determining that the size column corresponding to actual data is not set, processing for acquiring a data value is not performed. This processing operation is the same as that in the case of FIG. 10.

The relational database 103 transmits a result set of data sizes to the mediation unit 111 (S1005). This processing operation is the same as that in the case of FIG. 10.

The mediation unit 111 calculates the sum of data sizes. In addition, the mediation unit 111 compares the sum of data sizes with a threshold value, and determines availability of outputting of result data. Specifically, in a case where the sum of data sizes exceeds the threshold value, the mediation unit 111 determines that outputting of the result data is unavailable. In a case where the sum of data sizes does not exceed the threshold value, the mediation unit 111 determines that outputting of the result data is available.

The mediation unit 111 transmits that determination result to the application unit 107 (S2401).

In a case where the mediation unit 111 determines that outputting of the result data is available, the mediation unit 111 receives an output request from the application unit 107. On the other hand, in a case where the mediation unit 111 determines that outputting of the result data is unavailable, the mediation unit 111 may be allowed not to receive an output request from the application unit 107. This is the end of the description of the outline of the determination of availability of outputting, based on the example of FIG. 10.

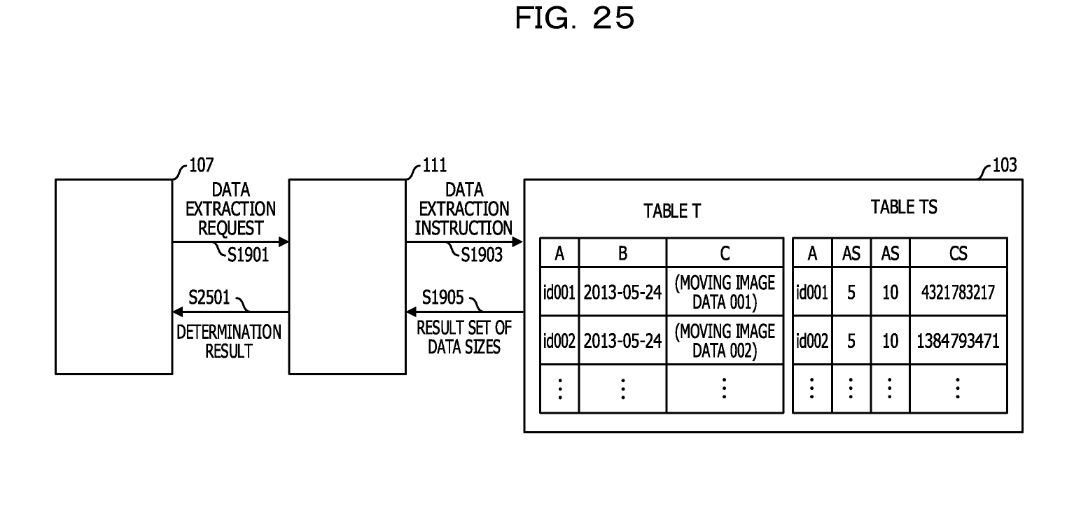

Subsequently, using FIG. 25, the outline of determination of availability of outputting, based on the example of FIG. 19, will be described. The application unit 107 transmits a data extraction request to the mediation unit 111 (S1901). This processing operation is the same as that in the case of FIG. 19.

Based on metadata, the mediation unit 111 determines whether or not a size column corresponding to actual data is set. In a case of determining that the size column corresponding to actual data is set, the mediation unit 111 generates a data extraction instruction (SELECT) for acquiring a size value from the size column, and transmits the data extraction instruction (SELECT) to the relational database 103 (S1903). This processing operation is the same as that in the case of FIG. 19.

The relational database 103 transmits a result set of the data sizes to the mediation unit 111 (S1905). This processing operation is the same as that in the case of FIG. 19.

The mediation unit 111 calculates the sum of data sizes. In addition, the mediation unit 111 compares the sum of data sizes with a threshold value, and determines availability of outputting of result data. Specifically, in a case where the sum of data sizes exceeds the threshold value, the mediation unit 111 determines that outputting of the result data is unavailable. In a case where the sum of data sizes does not exceed the threshold value, the mediation unit 111 determines that outputting of the result data is available.

The mediation unit 111 transmits that determination result to the application unit 107 (S2501).

In a case where the mediation unit 111 determines that outputting of the result data is available, the mediation unit 111 receives an output request from the application unit 107. On the other hand, in a case where the mediation unit 111 determines that outputting of the result data is unavailable, the mediation unit 111 may be allowed not to receive an output request from the application unit 107. This is the end of the description of the outline of the determination of availability of outputting, based on the example of FIG. 19.

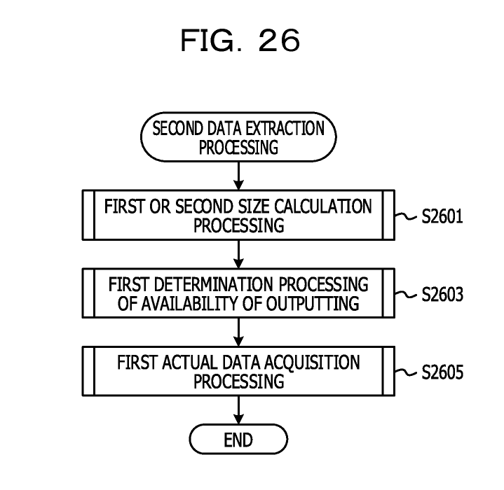

Data extraction in the present embodiment will be described. The mediation unit 111 executes second data extraction processing. As illustrated in FIG. 26, in the second data extraction processing, the calculation unit 217 in the extraction instruction unit 213 executes the first size calculation processing, or second size calculation processing (S2601), and, based on a calculated data size, the determination unit 2301 in the extraction instruction unit 213 executes first determination processing of availability of outputting (S2603). In addition, the second acquisition unit 219 in the extraction instruction unit 213 executes the first actual data acquisition processing (S903).

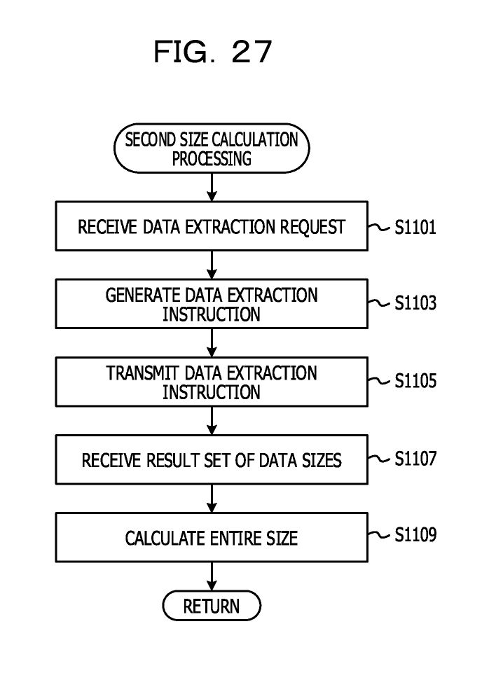

FIG. 27 illustrates the flow of the second size calculation processing according to the fourth embodiment. In a case where the reception unit 205 receives the data extraction request as illustrated in S1001 in FIG. 24 or S1901 in FIG. 25 (S1101), the first acquisition unit 215 generates a data extraction instruction (S1103). Through the transmission unit 203 as illustrated in S1003 in FIG. 24 or S1903 in FIG. 25, the first acquisition unit 215 transmits the data extraction instruction to the relational database 103 (S1105). In a case where the first acquisition unit 215 receives a result set of sizes from the relational database 103 through the reception unit 205 as illustrated in S1005 in FIG. 24 or S1905 in FIG. 25 (S1107), the calculation unit 217 calculates an entire size by summating the size values of respective columns (S1109). The processing operations in S1101 to S1109 are the same as those in the case of FIG. 11.

In a case where the first size calculation processing illustrated in FIG. 11 is executed, an entire size is transmitted in S1111. In a case where the second size calculation processing illustrated in FIG. 27 is executed, the transmission processing of the entire size illustrated in S1111 in FIG. 11 is omitted.

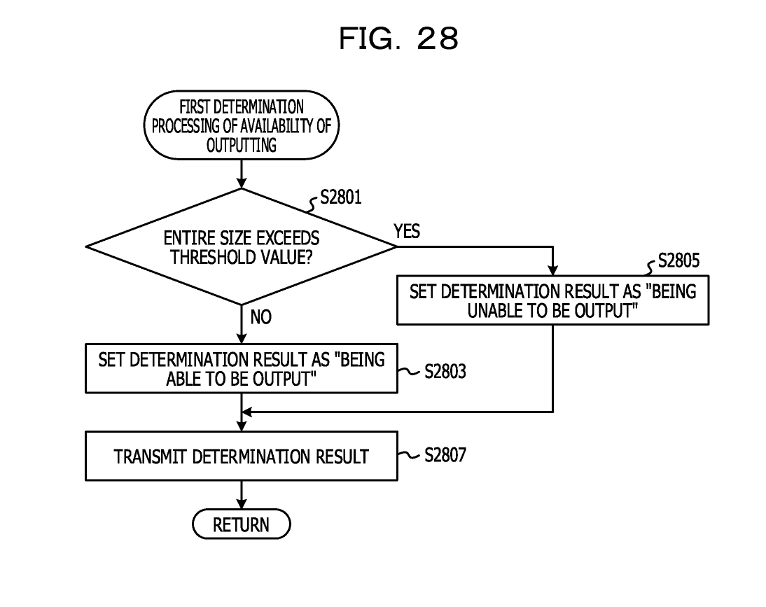

FIG. 28 illustrates the flow of the first determination processing of availability of outputting. The determination unit 2301 determines whether or not an entire size exceeds a threshold value (S2801). In a case of determining that the entire size does not exceed the threshold value, the determination unit 2301 sets a determination result as “being able to be output” (S2803). In a case of determining that the entire size exceeds the threshold value, the determination unit 2301 sets a determination result as “being unable to be output” (S2805). As illustrated in S2401 in FIG. 24 or S2501 in FIG. 25, the transmission unit 203 transmits the determination result (S2807).

In S2807, the transmission unit 203 may transmit the entire size along with the determination result.

The threshold value indicates, for example, a data amount able to be output from the relational database 103. Alternatively, the threshold value may be defied based on the data amount able to be output from the relational database 103.

The threshold value may be defined in accordance with the state of a network. For example, in a case where no error occurs in a network for connecting the mediation device 109 and the relational database device 101 to each other, the threshold value may be set to a large value. In addition, in a case where an error occurs in the network for connecting the mediation device 109 and the relational database device 101 to each other, the threshold value may be set to a small value.

According to the present embodiment, it is possible to predict availability of outputting of data extracted from the relational database 103. Accordingly, it is possible to avoid a situation that outputting of extracted data is interrupted. In addition, it is possible to omit determination relating to a data size, performed by the application unit 107.

Usually, the size of entire data to be output in response to a query remains obscure until the data is actually extracted and the extracted data is acquired. In addition, in a stage where the read-out data exceeds an upper limit value, an output error is determined. Therefore, in a case where the upper limit value is set to a large value, there is a problem that it takes a long time before the output error is determined.

In addition, in a case of a usual database, a mechanism for preliminarily knowing the size of an acquired data in such a manner as a file system is not provided. Since it is difficult to understand in advance how large the size of data extracted by a query is, usually availability of outputting is not preliminarily determined based on the data size.

### Fifth Embodiment

While, in the fourth embodiment, an example where whether to continue processing is determined on the mediation device 109 side has been described, an example where actual data acquisition processing is executed in the mediation device 109, based on a determination result, will be described in the present embodiment.

Hereinafter, an example of an operation based on FIG. 24 illustrated in the fourth embodiment and an example of an operation based on FIG. 25 illustrated in the fourth embodiment will be described.

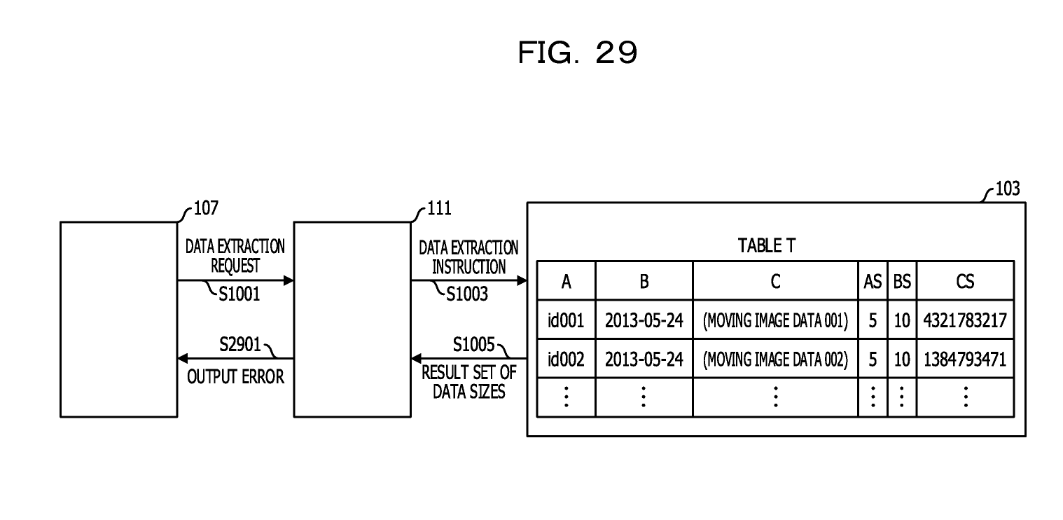

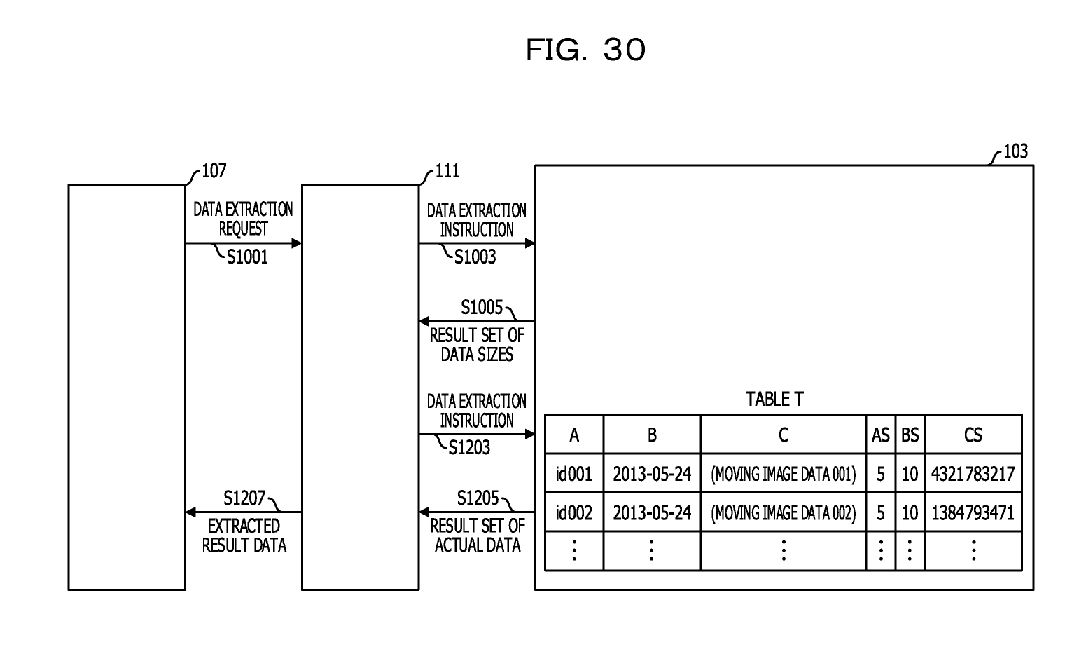

First, using FIG. 29 and FIG. 30, an example of an operation based on FIG. 24 illustrated in the fourth embodiment will be described. In FIG. 29, an operation where a determination result becomes “being unable to be output” and the mediation unit 111 notifies the application unit 107 of an output error will be described. FIG. 29 is based on the above-mentioned example of FIG. 10 in the same way as FIG. 24.

The application unit 107 transmits a data extraction request to the mediation unit 111 (S1001). This processing operation is the same as that in the case of FIG. 10 or FIG. 24.

The mediation unit 111 generates a data extraction instruction (SELECT) for acquiring a size value from a size column, and transmits the data extraction instruction (SELECT) to the relational database 103 (S1003). This processing operation is the same as that in the case of FIG. 10 or FIG. 24.

The relational database 103 transmits a result set of data sizes to the mediation unit 111 (S1005). This processing operation is the same as that in the case of FIG. 10 or FIG. 24.

The mediation unit 111 calculates the sum of data sizes. In addition, the mediation unit 111 compares the sum of data sizes with a threshold value, and determines availability of outputting of result data. This processing is the same as that in the case of FIG. 24.

In a case of determining that outputting of the result data is unavailable, the mediation unit 111 transmits an output error to the application unit 107 (S2901).

Next, using FIG. 30, an operation where a determination result becomes “being able to be output” and the mediation unit 111 acquires actual data will be described. S1001 to S1005 are the same as those in the above-mentioned FIG. 29. In addition, that the mediation unit 111 calculates the sum of data sizes is the same as in the above-mentioned FIG. 29.

In a case where the mediation unit 111 determines that outputting of result data is available, the mediation unit 111 generates and transmits a data extraction instruction (SELECT), to the relational database 103 in the same way as in the case of FIG. 12 (S1203).

The relational database 103 transmits a result set of actual data to the mediation unit 111 in the same way as in the case of FIG. 12 (S1205).

The mediation unit 111 acquires actual data from the result set of actual data, changes the actual data to a predetermined format, and transmits the actual data to the application unit 107 in the same way as in the case of FIG. 12 (S1207).

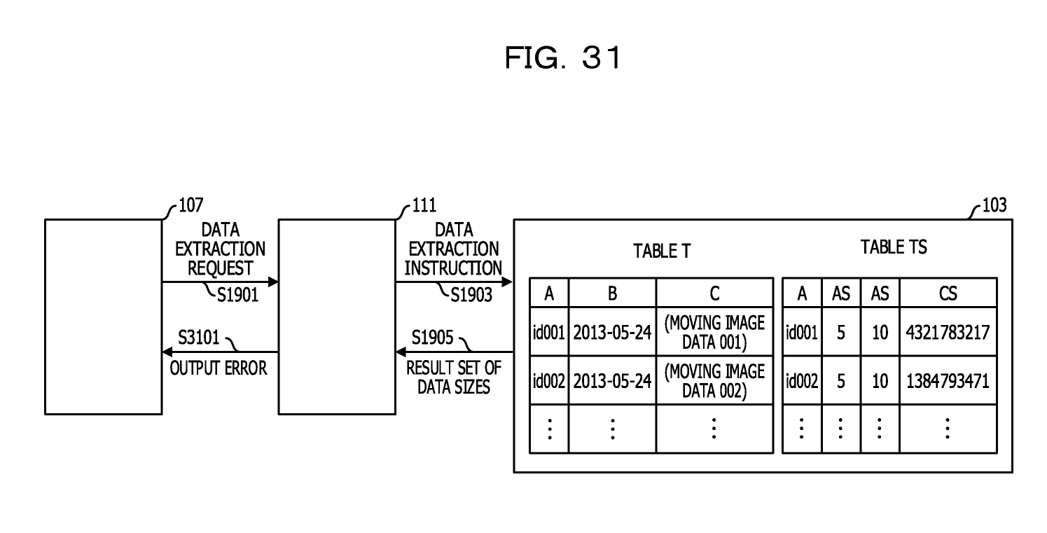

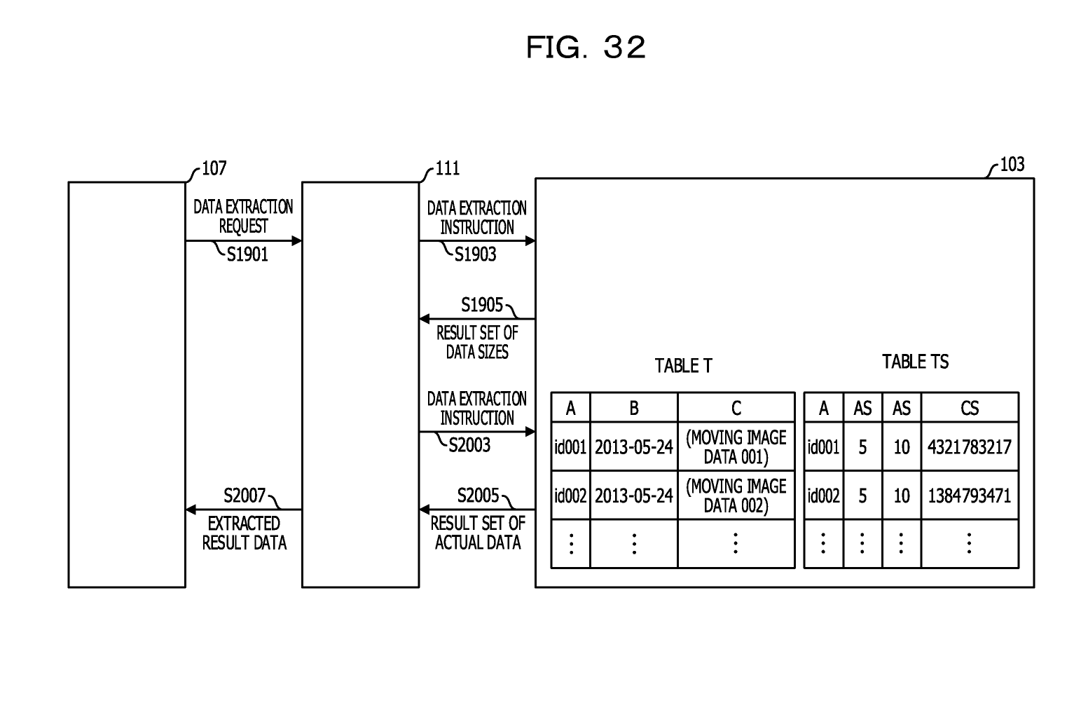

Next, using FIG. 31 and FIG. 32, an example of an operation based on FIG. 25 illustrated in the fourth embodiment will be described. In FIG. 31, an operation where a determination result becomes “being unable to be output” and the mediation unit 111 notifies the application unit 107 of an output error will be described. FIG. 31 is based on the above-mentioned example of FIG. 19 in the same way as FIG. 25.

The application unit 107 transmits a data extraction request to the mediation unit 111 (S1901). This processing operation is the same as that in the case of FIG. 19 or FIG. 25.

The mediation unit 111 generates a data extraction instruction (SELECT) for acquiring a size value from a size column, and transmits the data extraction instruction (SELECT) to the relational database 103 (S1903). This processing operation is the same as that in the case of FIG. 19 or FIG. 25.

The relational database 103 transmits a result set of data sizes to the mediation unit 111 (S1905). This processing operation is the same as that in the case of FIG. 19 or FIG. 25.

The mediation unit 111 calculates the sum of data sizes. In addition, the mediation unit 111 compares the sum of data sizes with a threshold value, and determines availability of outputting of result data. This processing is the same as that in the case of FIG. 25.

In a case of determining that outputting of the result data is unavailable, the mediation unit 111 transmits an output error to the application unit 107 (S1901).

Next, using FIG. 32, an operation where a determination result becomes “being able to be output” and the mediation unit 111 acquires actual data will be described. S1901 to S1905 are the same as those in the above-mentioned FIG. 31. In addition, that the mediation unit 111 calculates the sum of data sizes is the same as in the above-mentioned FIG. 31.

In a case where the mediation unit 111 determines that outputting of the result data is available, the mediation unit 111 generates and transmits a data extraction instruction (SELECT), to the relational database 103 in the same way as in the case of FIG. 20 (S2003).

The relational database 103 transmits a result set of actual data to the mediation unit 111 in the same way as in the case of FIG. 20 (S2005).

The mediation unit 111 acquires actual data from the result set of actual data, changes the actual data to a predetermined format, and transmits the actual data to the application unit 107 in the same way as in the case of FIG. 20 (S2007).

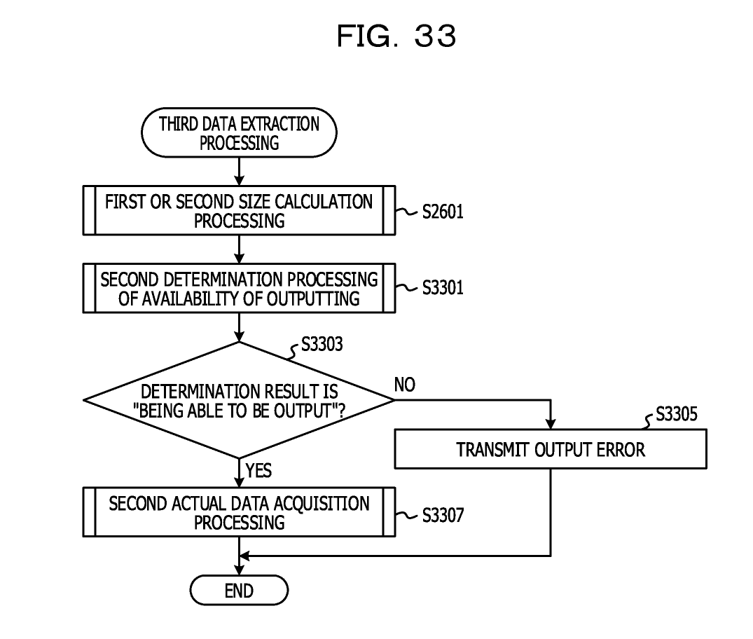

Subsequently, data extraction in the present embodiment will be described. The mediation unit 111 executes third data extraction processing. As illustrated in FIG. 33, in the third data extraction processing, the calculation unit 217 in the extraction instruction unit 213 executes the first size calculation processing or the second size calculation processing (S2601), and, based on a calculated data size, the determination unit 2301 in the extraction instruction unit 213 executes second determination processing of availability of outputting (S3301). The second size calculation processing is as described above using FIG. 26.

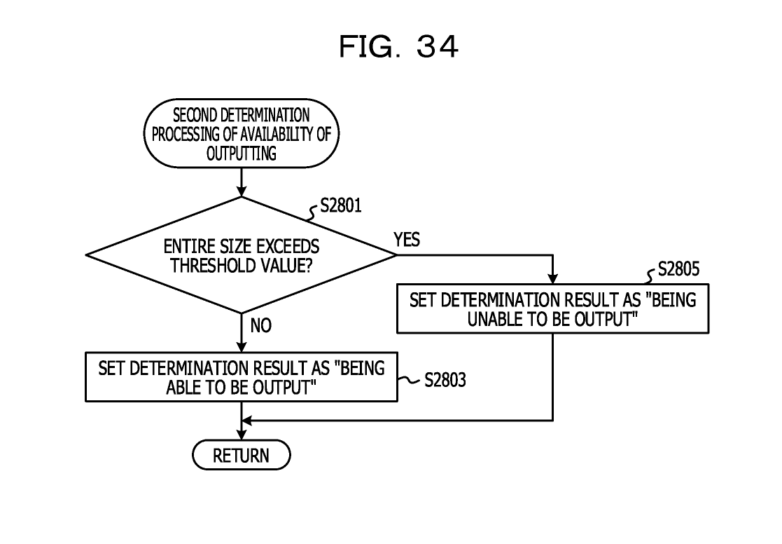

FIG. 34 illustrates the flow of the second determination processing of availability of outputting according to the fifth embodiment. In the second determination processing of availability of outputting, the transmission processing operation of the determination result illustrated in S2807 within the flow of the first determination processing of availability of outputting illustrated in FIG. 28 is omitted.

Returning to the description of FIG. 33, based on whether or not a determination result is “being able to be output”, the extraction instruction unit 213 branches the processing (S3303). In a case where the determination result is not “being able to be output”, in other words, in a case where the determination result is “being unable to be output”, the transmission unit 203 transmits an output error to the application unit 107 (S3305).

On the other hand, in a case where the determination result is “being able to be output”, the transmission unit 203 executes second actual data acquisition processing (S3307).

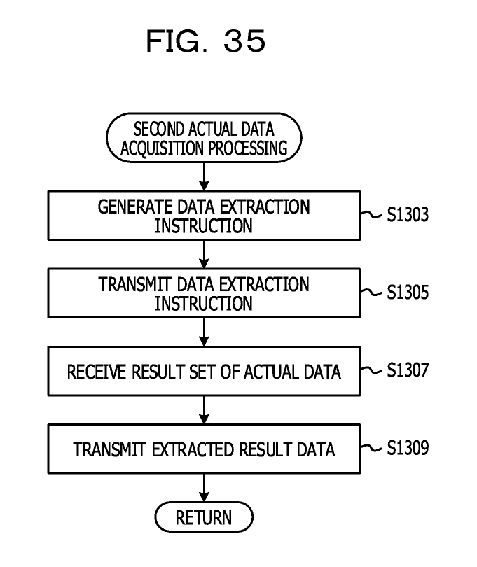

FIG. 35 illustrates the flow of the second actual data acquisition processing according to the fifth embodiment. The determination processing in S1301 within the flow of the first actual data acquisition processing illustrated in FIG. 13 is omitted. The processing operations in S1303 to S1309 are the same as those in the case of the flow of the first actual data acquisition processing. This is the end of the description of the data extraction in the present embodiment.

In the present embodiment, it is possible to execute data acquisition processing where outputting of data from the relational database 103 is predicted to succeed. Accordingly, it is possible to avoid a situation that outputting of extracted data is interrupted. In addition, it is possible to omit determination relating to a data size, performed by the application unit 107.

In each of the first embodiment to the fifth embodiment, an example where a data size concerning item-based actual data is held under the assumption that data for each item (actual data set in a column) is extracted has been described. In these embodiments, it is possible to correctly obtain the size of entire data actually extracted, based on an item-based data size.

### Sixth Embodiment

In or after the present embodiment, an example where the item-based data size is not held and a record-based data size, in other words, the size of data according to a plurality of items is held will be described. In the present embodiment, an example altered based on the first embodiment will be described.

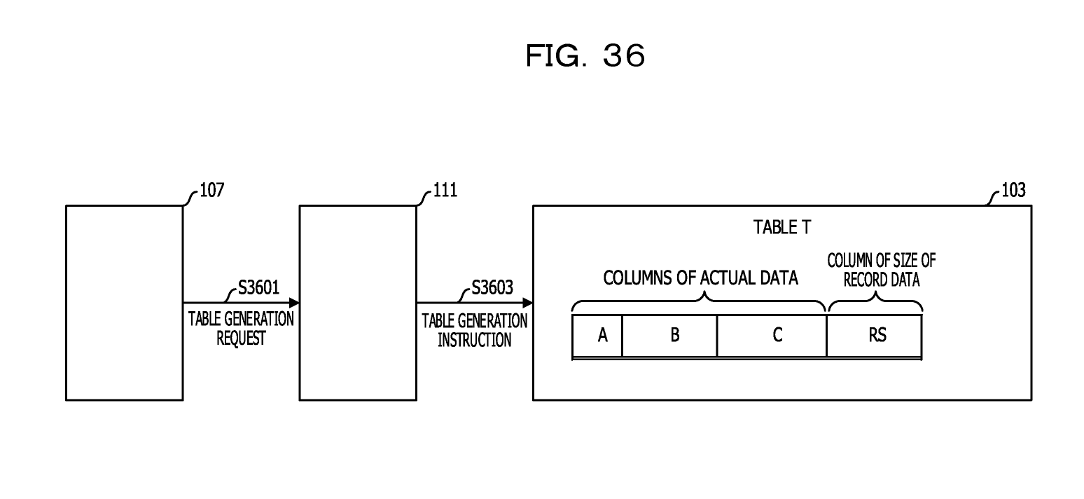

FIG. 36 illustrates the outline of table generation according to the sixth embodiment. The application unit 107 transmits a table generation request to the mediation unit 111 (S3601). The table generation request includes a table name. In addition, the table generation request specifies a set of a column name and a data type for each column. The table generation request in this example includes a set of a table name, “T”, a column name, “A”, and a data type, “char(5)”, a set of a column name, “B”, and a data type, “datetime”, and a set of a column name, “C”, and a data type, “blob(8G)”. Texts in parentheses included in the data types indicate data sizes.

In response to that request, the mediation unit 111 generates and transmits a table generation instruction (CREATE TABLE), to the relational database 103 (S3603). Such a table generation instruction as, for example, “create table T (A char(5), B datetime, C blob(8G), RS int)” is generated.

This table generation instruction includes the following contents. A table of the table name, “T”, is generated. A column whose column name is “A” and whose data type is “char(5)” is generated. A column whose column name is “B” and whose data type is “datetime” is generated. A column whose column name is “C” and whose data type is “blob(8G)” is generated. A column whose column name is “RS” and whose data type is “int” is generated. Hereinafter, a column whose column name is “A” is called a column A. A column whose column name is “B” is called a column B. A column whose column name is “C” is called a column C. A column whose column name is “RS” is called a column RS.

In accordance with the above-mentioned table generation instruction, a table T is generated in the relational database 103 as illustrated in the drawing. The column A, the column B, and the column C out of the above-mentioned columns are columns for storing therein pieces of actual data. On the other hand, the column RS is a column for storing therein size data. In the column RS, a value indicating the sum of the size of actual data stored in the column A, the size of actual data stored in the column B, and the size of actual data stored in the column C is stored.

Subsequently, using FIG. 4, processing in the mediation unit 111 in the table generation will be described. In a case where the reception unit 205 receives the table generation request as illustrated in S3601 in FIG. 36 (S401), the generation instruction unit 207 generates the table generation instruction in response to the table generation request (S403).

At this time, the generation instruction unit 207 causes a table name (for example, “T”) included in the table generation request to be included in the table generation instruction without change. In addition, the generation instruction unit 207 causes a column name (for example, “A”) and a data type (for example, “char(5)”) included in the table generation request to be included in the table generation instruction without change. Furthermore, the generation instruction unit 207 adds the size column name, “RS”, and the data type, “int”, to the table generation instruction.

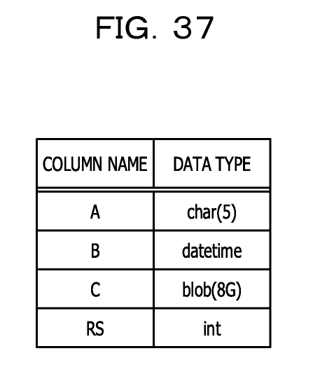

At this time, the reception unit 205 generates metadata. FIG. 37 illustrates metadata in the table T. A first record indicates that the column name of a first column in the table T is “A” and the data type of the first column is “char(5)”.

A second record indicates that the column name of a second column in the table T is “B” and the data type of the second column is “datetime”.

A third record indicates that the column name of a third column in the table T is “C” and the data type of the third column is “blob(8G)”.

A fourth record indicates that the column name of a fourth column in the table T is “RS” and the data type of the fourth column is “int”.

The transmission unit 203 transmits the table generation instruction to the relational database 103 as illustrated in S3603 in FIG. 36 (S405).

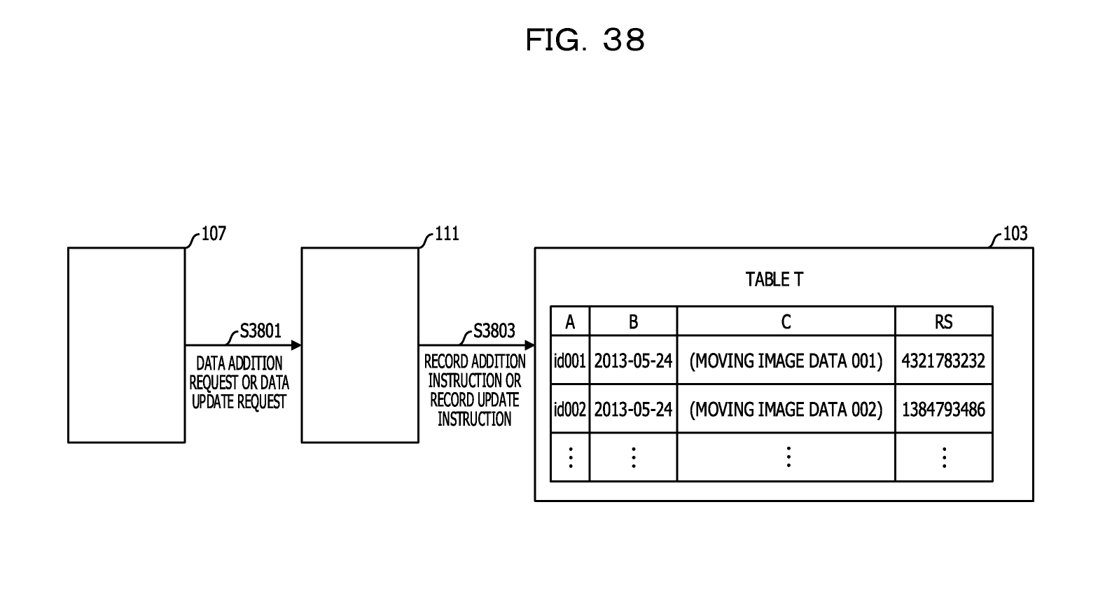

Subsequently, FIG. 38 illustrates the outlines of data addition and data update according to the sixth embodiment. The application unit 107 transmits a data addition request or a data update request to the mediation unit 111 (S3801). The data addition request specifies a set of a column name and actual data. The data addition request in this example includes a set of the column name, “A”, and actual data, ‘id001’, a set of the column name, “B”, and actual data, ‘2013-05-24’, and a set of the column name, “C”, and the identification information of moving image data. The moving image data is attached to the data addition request.

The data update request specifies a set of a column name and actual data in the same way as the data addition request. In a case of the data update request, data for identifying a record to serve as an update target is included.

In the same way as in the above-mentioned embodiment, in response to the data addition request, the mediation unit 111 generates and transmits a record addition instruction (INSERT), to the relational database 103 (S3803). Alternatively, in response to the data update request, the mediation unit 111 generates and transmits a record update instruction (UPDATE), to the relational database 103 (S3803).

The mediation unit 111 summates the size values of pieces of actual data to be registered, and stores the sum of the size values in a size column.

In this example, since the size value of actual data in the column A is 5, the size value of actual data in the column B is 10, and the size value of actual data in the column C is 4321783217, a size value, 4321783232, is obtained by summating these size values. In addition, such a data addition instruction as “insert into T (A,B,C,RS) values (‘id001’,‘2013-05-24’,?,4321783232)” is generated. In the above-mentioned “?” portion within the parameter, an input stream of moving image data is set.

This data addition instruction includes the following contents. A record is added to the table of the table name, “T”. Actual data, ‘id001’, is set in the column A. Actual data, ‘2013-05-24’, is set in the column B. The moving image data is set in the column C. In this regard, however, actually the moving image data is saved outside of the table, and information for leading to the moving image data is stored in the column C. The size value of 4321783232 is set in the column RS.

As illustrated in the drawing, a new record is added to the table T in the relational database 103. A first record is an example of addition by the above-mentioned data addition instruction. A second record indicates an example generated as a result of transmitting the moving image data while attaching the moving image data to such a data addition instruction as “insert into T (A,B,C,RS) values (‘id002’,‘2013-05-24’,?,1384793486)”.

In addition, in a case of transmitting the data update instruction, new data is set in an existing record. Specifically, actual data is rewritten, and a size value is rewritten.

In a case where the reception unit 205 receives the data addition request in accordance with the flow of the data addition processing illustrated in FIG. 7 as illustrated in S3801 in FIG. 38 (S701), the addition instruction unit 209 calculates the sizes of pieces of actual data to be added, and calculates the sum of these sizes (S703). If the actual data is, for example, ‘id001’, a size value is 5 bytes. In addition, if the actual data is ‘2013-05-24’, a size value is 10 bytes. The size value of moving image data is measured from moving image data serving as a source. In addition, a size value obtained by summating these size values is calculated.

The addition instruction unit 209 generates the above-mentioned data addition instruction (S705). At this time, the addition instruction unit 209 causes a column name (for example, “A”) and actual data (for example, ‘id001’) included in the data addition request to be included in the data addition instruction without change. Furthermore, the addition instruction unit 209 causes the size column “RS” and the size value (for example, “4321783232”) calculated in S703 to be included in the data addition instruction.

The transmission unit 203 transmits the data addition instruction to the relational database 103 as illustrated in S3803 in FIG. 38 (S707).

In a case where the reception unit 205 receives the data update request in accordance with the flow of the data update processing illustrated in FIG. 8 as illustrated in S3801 in FIG. 38 (S801), the update instruction unit 211 calculates the size value of actual data to be newly written (S803). The size value of actual data is calculated in the same way as in the case of S703 in FIG. 7.

The update instruction unit 211 generates the data update instruction (S805). At this time, the update instruction unit 211 causes a column name and actual data included in the data update request to be included in the data update instruction without change. Furthermore, the update instruction unit 211 causes the size column “RS” and the size value calculated in S803 to be included in the data update instruction.

The transmission unit 203 transmits the data update instruction to the relational database 103, as illustrated in S3803 in FIG. 38 (S807).

Subsequently, a procedure where the application unit 107 extracts data from the relational database 103 will be described. This procedure includes the size calculation phase and the actual data acquisition phase, in the same way as in the first embodiment. Therefore, as illustrated in FIG. 9, in the first data extraction processing, after the calculation unit 217 in the extraction instruction unit 213 executes the first size calculation processing (S901), the second acquisition unit 219 in the extraction instruction unit 213 executes the first actual data acquisition processing (S903).

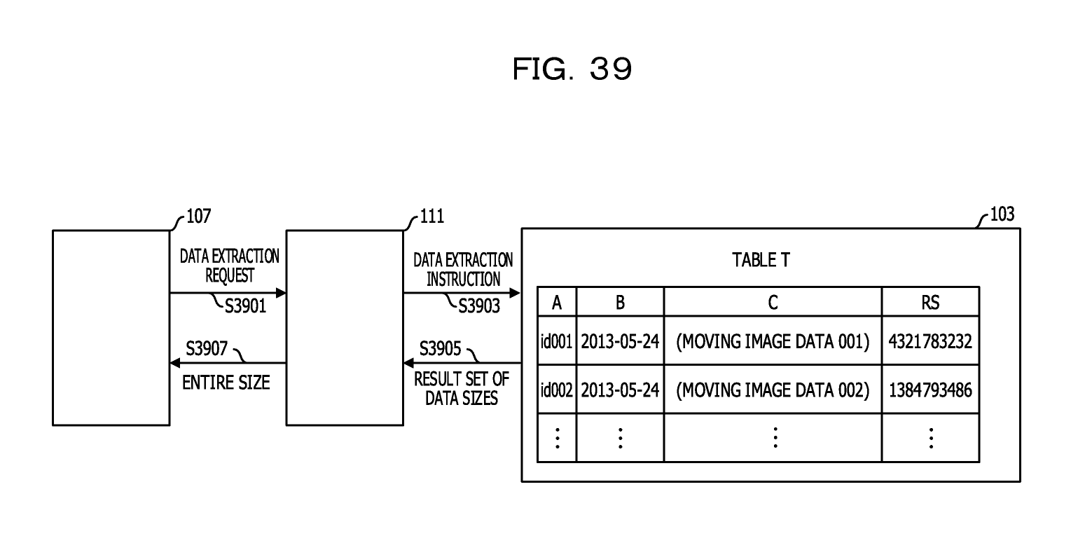

First, the size calculation phase will be described. FIG. 39 illustrates the outline of size calculation according to the sixth embodiment. The application unit 107 transmits a data extraction request to the mediation unit 111 (S3901). The data extraction request includes an extraction condition and the specification of an output table. In other words, in the sixth embodiment, the output table is specified in place of the output item in the above-mentioned embodiment. A case where the output table is specified means that all pieces of actual data included in a table are acquired.

Hereinafter, an example where the output table is “T” will be described. In addition, the extraction condition is “A=id001”. In other words, a record where the value of the column A is ‘id001’ becomes a target of data extraction.

The mediation unit 111 generates a data extraction instruction (SELECT) for acquiring a size value from a size column, and transmits the data extraction instruction (SELECT) to the relational database 103 (S3903).

The relational database 103 transmits a result set of data sizes to the mediation unit 111 (S3905). The mediation unit 111 calculates the sum of the data sizes, and transmits the result thereof to the application unit 107 (S3907).

In a case where the reception unit 205 receives the data extraction request in accordance with the flow of the first size calculation processing illustrated in FIG. 11 as illustrated in S3901 in FIG. 39 (S1101), the first acquisition unit 215 generates the data extraction instruction (S1103). At this time, “RS” is set as the size column name. Such a data extraction instruction as, for example, “SELECT RS FROM T WHERE A=id001” is generated.

Through the transmission unit 203 as illustrated in S3903 in FIG. 39, the first acquisition unit 215 transmits the data extraction instruction to the relational database 103 (S1105). In a case where the first acquisition unit 215 receives a result set of sizes from the relational database 103 through the reception unit 205 as illustrated in S3905 in FIG. 39 (S1107), the calculation unit 217 calculates an entire size by summating the size values of respective columns (S1109). The transmission unit 203 transmits the entire size as illustrated in S3907 in FIG. 39 (S1111). This is the end of the description of the data calculation phase.

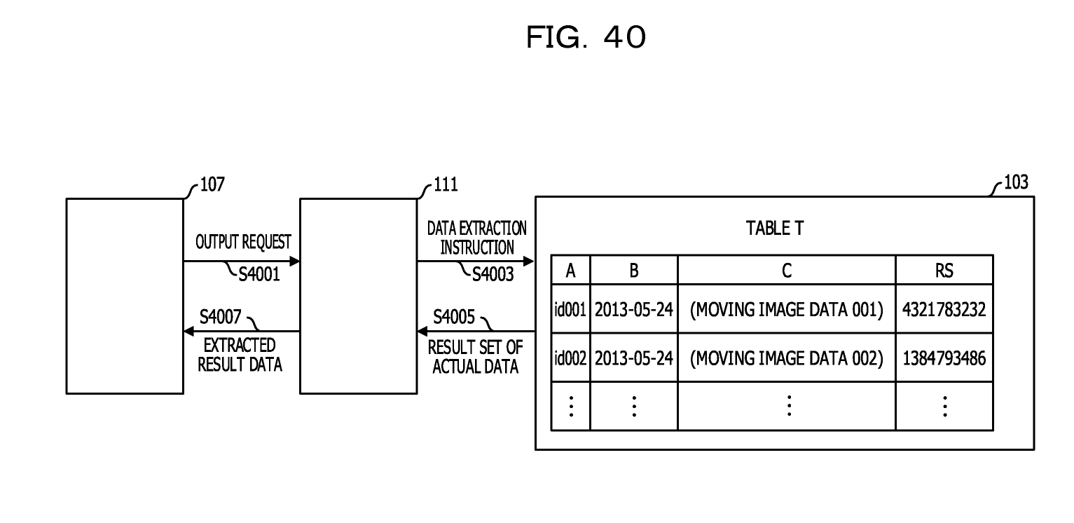

Next, the actual data acquisition phase will be described. FIG. 40 illustrates the outline of actual data acquisition according to the sixth embodiment. In a case where the application unit 107 receives an entire size, whether or not to continue processing is determined on the application device 105 side in the same way as in the above-mentioned embodiment.

The application unit 107 in the application device 105 may perform the processing illustrated in the third embodiment.

In a case of determining to continue processing, the application unit 107 transmits an output request to the mediation unit 111 (S4001). In a case of determining not to continue processing, the processing is terminated at that time.

Upon receiving the output request, the mediation unit 111 generates and transmits a data extraction instruction (SELECT), to the relational database 103 (S4003). At this time, the mediation unit 111 generates a data extraction instruction for extracting all pieces of actual data included in a record.

The relational database 103 transmits a result set of actual data to the mediation unit 111 (S4005). In the result set of actual data, a record includes the actual data of the column A, the actual data of the column B, and the actual data of the column C.

The mediation unit 111 acquires actual data from the result set of actual data, changes the actual data to a predetermined format, and transmits the actual data to the application unit 107 (S4007). At this time, the mediation unit 111 may transmit the result set of actual data to the application unit 107 without change.

In accordance with the flow of the first actual data acquisition processing illustrated in FIG. 13, based on whether or not the reception unit 205 receives the output request, the extraction instruction unit 213 branches processing (S1301).

In a case where the reception unit 205 does not receive the output request within a predetermined time period, the processing in FIG. 13 is terminated, processing returns to the processing in FIG. 9, and the first data extraction processing is terminated.

In a case where the reception unit 205 receives the output request, the second acquisition unit 219 generates a data extraction instruction, based on the data extraction request received in S3901 in FIG. 39 (S1303).

The transmission unit 203 transmits the data extraction instruction to the relational database 103 (S1305). The reception unit 205 receives a result set of actual data from the relational database 103 (S1307).

The transmission unit 203 transmits extraction result data to the application unit 107 (S1309). The extraction result data may be data obtained by changing actual data extracted from the result set to a predetermined format or may be the result set itself.

According to the present embodiment, since the record-based size value is set, processing for obtaining the size of data extracted from the relational database 103 in units of records is performed at high speed.

### Seventh Embodiment

In the present embodiment, an example altered, based on the sixth embodiment, so that whether to continue processing is determined on the mediation device 109 will be described.

The module configuration of the mediation unit 111 is as illustrated in FIG. 23.

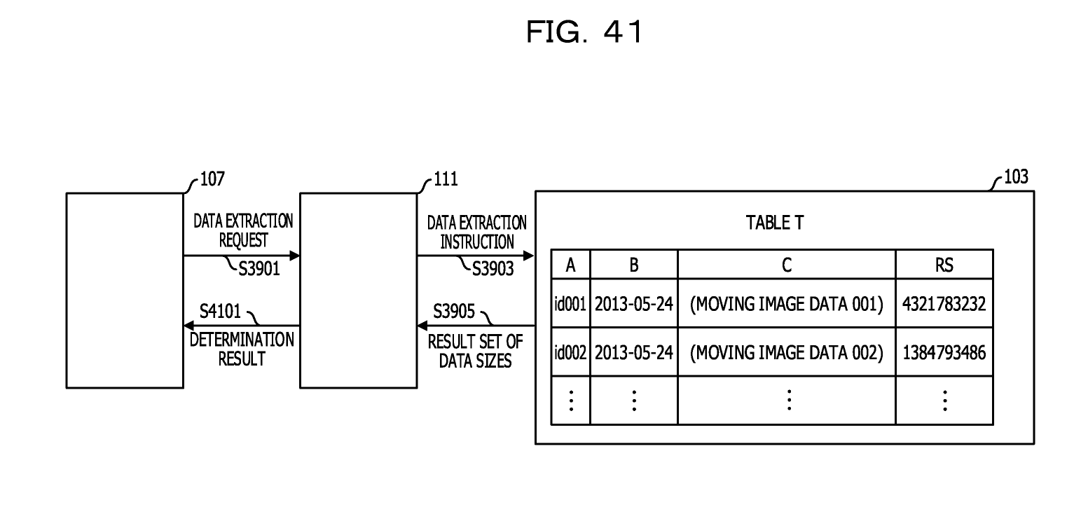

FIG. 41 illustrates the outline of determination of availability of outputting according to the seventh embodiment. FIG. 41 is based on the above-mentioned example of FIG. 39. The application unit 107 transmits a data extraction request to the mediation unit 111 (S3901). This processing operation is the same as that in the case of FIG. 39.

The mediation unit 111 generates a data extraction instruction (SELECT) for acquiring a size value from a size column, and transmits the data extraction instruction (SELECT) to the relational database 103 (S3903). This processing operation is the same as that in the case of FIG. 39.

The relational database 103 transmits a result set of data sizes to the mediation unit 111 (S3905). This processing operation is the same as that in the case of FIG. 39.

The mediation unit 111 calculates the sum of data sizes. In addition, the mediation unit 111 compares the sum of data sizes with a threshold value, and determines availability of outputting of result data. Specifically, in a case where the sum of data sizes exceeds the threshold value, the mediation unit 111 determines that outputting of the result data is unavailable. In a case where the sum of data sizes does not exceed the threshold value, the mediation unit 111 determines that outputting of the result data is available.

That determination result is transmitted to the application unit 107 (S4101).

In a case of determining that outputting of the result data is available, the mediation unit 111 receives an output request from the application unit 107. On the other hand, in a case of determining that outputting of the result data is unavailable, the mediation unit 111 may be allowed not to receive an output request from the application unit 107. This is the end of the description of the outline of the determination of availability of outputting, based on the example of FIG. 39.

Data extraction in the present embodiment will be described. As illustrated in FIG. 26, in the second data extraction processing, the calculation unit 217 in the extraction instruction unit 213 executes the first size calculation processing or the second size calculation processing (S2601), and, based on a calculated data size, the determination unit 2301 in the extraction instruction unit 213 executes the first determination processing of availability of outputting (S2603). In addition, the second acquisition unit 219 in the extraction instruction unit 213 executes the first actual data acquisition processing (S903).

In a case where the first size calculation processing illustrated in FIG. 11 is executed, an entire size is transmitted in S1111. In a case where the second size calculation processing illustrated in FIG. 27 is executed, the transmission processing of the entire size illustrated in S1111 in FIG. 11 is omitted.

The first determination processing of availability of outputting is the same as the example of the fourth embodiment described using FIG. 28.

The first actual data acquisition processing is the same as in the case of the sixth embodiment.

By doing this, even in a case where data sizes are set in units of records in such a way as in the sixth embodiment, it is possible for the mediation unit 111 to determine availability of outputting of data, in such a way as in the fourth embodiment.

### Eighth Embodiment

In the present embodiment, an example altered, based on the sixth embodiment, so that the actual data acquisition processing is executed in the mediation device 109, based on a determination result, will be described.

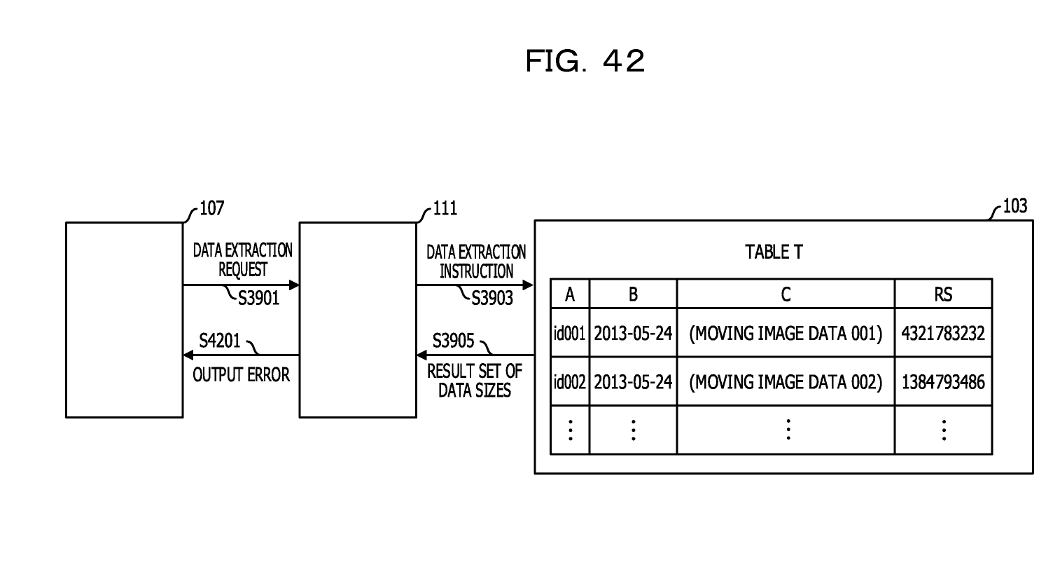

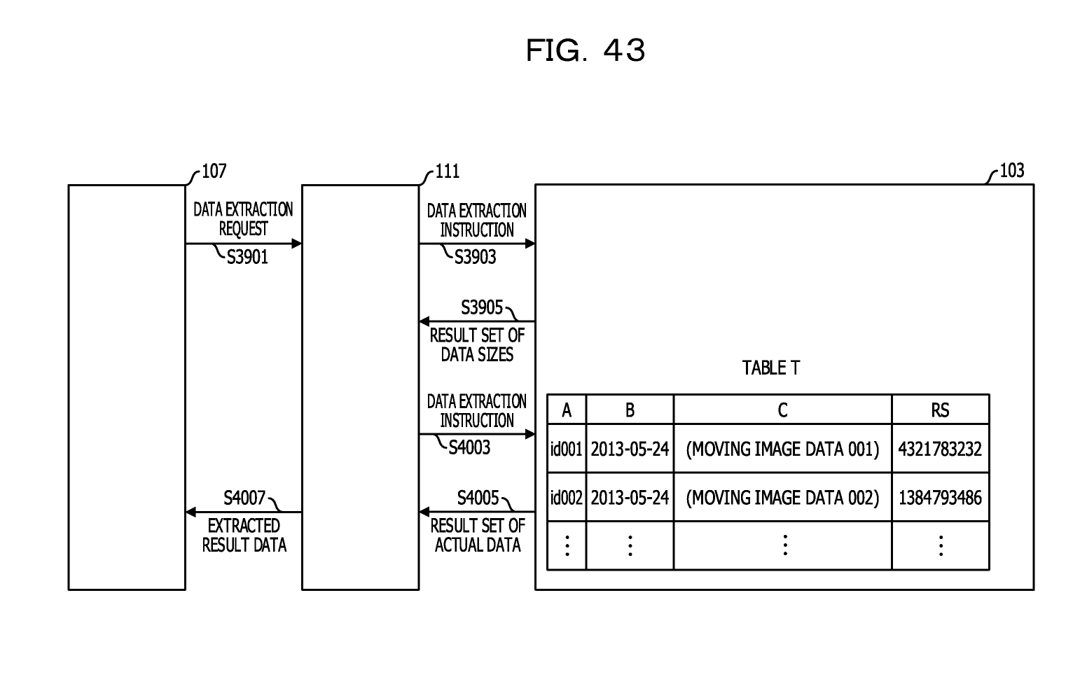

Using FIG. 42 and FIG. 43, an example of an operation based on FIG. 39 illustrated in the sixth embodiment will be described. In FIG. 42, an operation where a determination result becomes “being unable to be output” and the mediation unit 111 notifies the application unit 107 of an output error will be described.

The application unit 107 transmits a data extraction request to the mediation unit 111 (S3901). This processing operation is the same as that in the case of FIG. 39.

The mediation unit 111 generates a data extraction instruction (SELECT) for acquiring a size value from a size column, and transmits the data extraction instruction (SELECT) to the relational database 103 (S3903). This processing operation is the same as that in the case of FIG. 39.

The relational database 103 transmits a result set of data sizes to the mediation unit 111 (S3905). This processing operation is the same as that in the case of FIG. 39.

The mediation unit 111 calculates the sum of data sizes. In addition, the mediation unit 111 compares the sum of data sizes with a threshold value, and determines availability of outputting of result data. This processing is the same as that in the case of FIG. 39.

In a case of determining that outputting of the result data is unavailable, the mediation unit 111 transmits an output error to the application unit 107 (S4201).

Next, using FIG. 43, an operation where a determination result becomes “being able to be output” and the mediation unit 111 acquires actual data will be described. S3901 to S3905 are the same as those in the above-mentioned FIG. 42. In addition, that the mediation unit 111 calculates the sum of data sizes is the same as in the above-mentioned FIG. 42.

In a case of determining that outputting of the result data is available, the mediation unit 111 generates and transmits a data extraction instruction (SELECT), to the relational database 103 in the same way as in the case of FIG. 40 (S4003).

The relational database 103 transmits a result set of actual data to the mediation unit 111 in the same way as in the case of FIG. 40 (S4005).

The mediation unit 111 acquires actual data from the result set of actual data, changes the actual data to a predetermined format, and transmits the actual data to the application unit 107 in the same way as in the case of FIG. 40 (S4007).

The flow of processing according to the present embodiment is the same as that in the case of the fifth embodiment described using FIG. 33 to FIG. 35. In this regard, however, S1101 to S1109 in the flow of the second size calculation processing in FIG. 27 are the same as those in the sixth embodiment. In addition, S1303 to S1309 in the flow of the second actual data acquisition processing in FIG. 35 are the same as those in the sixth embodiment.

In the present embodiment, it is possible to execute data acquisition processing where outputting of data from the relational database 103 is predicted to succeed. Accordingly, it is possible to avoid a situation that outputting of extracted data is interrupted. In addition, it is possible to omit determination relating to a data size, performed by the application unit 107.

### Ninth Embodiment

In the present embodiment, an example altered, based on the second embodiment, so that the data size of an entire record including a plurality of columns is held will be described.

In the present embodiment, a record-based data size is set in another table. Accordingly, the present embodiment is useful for a case where a size value is set for a record in an already existing table.

A state where the table T is held in the relational database 103 as illustrated in FIG. 14 is assumed. The column A, the column B, and the column C are columns for storing therein pieces of actual data.

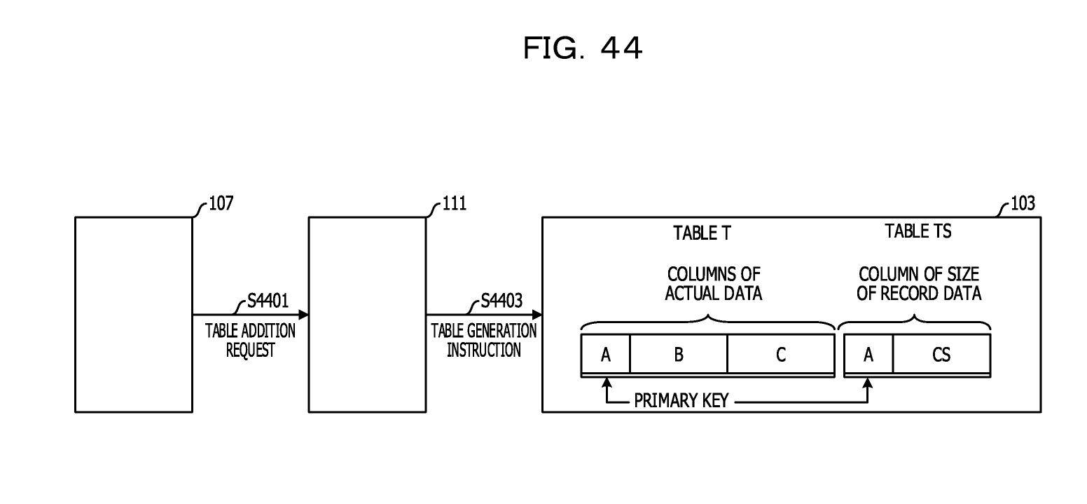

Next, using FIG. 44, the outline of table generation according to the ninth embodiment will be described. The application unit 107 transmits a table addition request to the mediation unit 111 (S4401). The table addition request includes a table name (in this example, “T”) for specifying a table to serve as a target.

Subsequently, using FIG. 4, processing in the mediation unit 111 in the table generation will be described. In a case where the reception unit 205 receives the table generation request as illustrated in S4401 in FIG. 44 (S401), the generation instruction unit 207 generates the table generation instruction in response to the table generation request (S403).

At this time, the generation instruction unit 207 identifies a table name to be newly added. In this example, the generation instruction unit 207 adds “S” to the specified table name (for example, “T”), and identifies the table name to be newly added. The generation instruction unit 207 causes that table name to be included in the table generation instruction.

Furthermore, the generation instruction unit 207 adds a column name to serve as a primary key and the data type thereof to the table generation instruction. In addition, the generation instruction unit 207 adds a size column name (in this example, “RS”) and the data type, “int”, to the table generation instruction.

Metadata in the existing table T, assumed in this example, is as illustrated in FIG. 16. In this regard, however, since, in this example, the field for setting the related column name is not used, this field may be omitted.

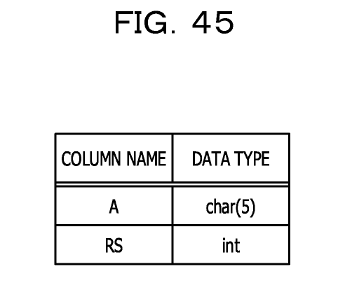

FIG. 45 illustrates an example of metadata concerning the added table TS. A first record indicates that the column name of a first column in the table TS is “A” and the data type of the first column is “char(5)”.

A second record indicates that the column name of a second column in the table TS is “RS” and the data type of the second column is “int”. This column stores therein the entire size of a record identified by the column A serving as the primary key.

The transmission unit 203 transmits the table generation instruction to the relational database 103 as illustrated in S4403 in FIG. 44 (S405).

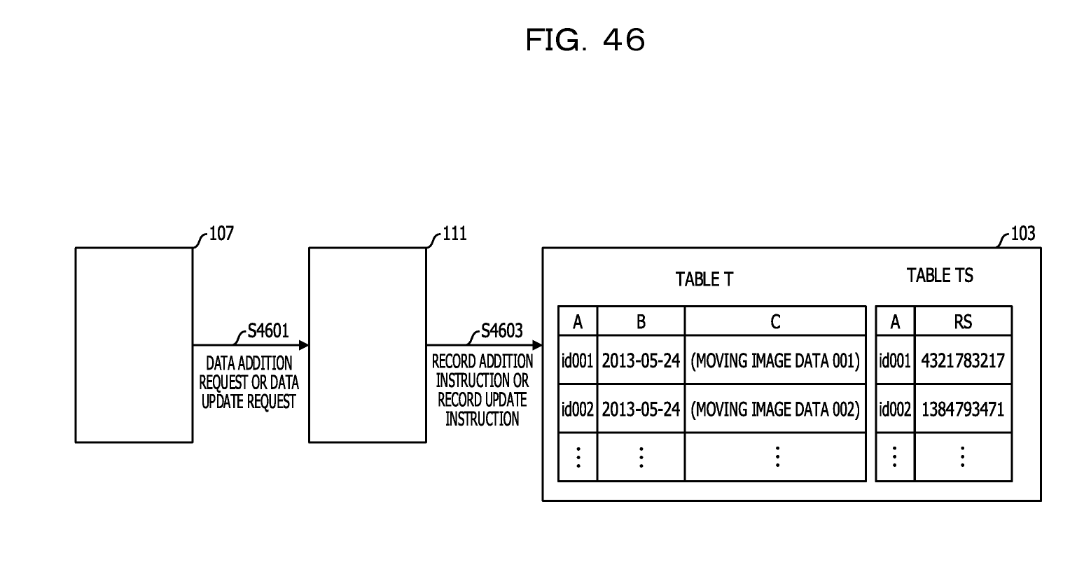

Subsequently, FIG. 46 illustrates the outlines of data addition and data update according to the ninth embodiment. The application unit 107 transmits a data addition request or a data update request to the mediation unit 111 (S4601). The data addition request specifies a set of a column name and actual data. The data addition request in this example includes a set of the column name, “A”, and actual data, ‘id001’, a set of the column name, “B”, and actual data, ‘2013-05-24’, and a set of the column name, “C”, and the identification information of moving image data. The moving image data is attached to the data addition request.

The data update request specifies a set of a column name and actual data in the same way as the data addition request. In a case of the data update request, data for identifying a record to serve as an update target is included.

In response to the data addition request, the mediation unit 111 generates and transmits a record addition instruction (INSERT), to the relational database 103 (S4603). Alternatively, in response to the data update request, the mediation unit 111 generates and transmits a record update instruction (UPDATE), to the relational database 103 (S4603).

The mediation unit 111 stores, in the size column, the sum of the size values of all pieces of actual data included in a record.

At this time, two data addition instructions are generated. First, such a data addition instruction as “insert into T (A,B,C) values (‘id001’,‘2013-05-024’,?)” is generated. In the above-mentioned “?” portion within the parameter, an input stream of moving image data is set.

This data addition instruction includes the following contents. A record is added to the table of the table name, “T”. Actual data, ‘id001’, is set in the column A. Actual data, ‘2013-05-24’, is set in the column B. The moving image data is set in the column C. In this regard, however, actually the moving image data is saved outside of the table, and information for leading to the moving image data is stored in the column C.

Furthermore, such a data addition instruction as “insert into TS (A,RS) values (‘id001’,4321783232)” is generated.

This data addition instruction includes the following contents. A record is added to the table of the table name, “TS”. Actual data, ‘id001’, is set in the column A. The size value of 4321783232 is set in the column RS.

As illustrated in FIG. 46, a new record is added to the table T in the relational database 103. A first record in the table T is added by the above-mentioned first data addition instruction. Furthermore, a new record is added to the table TS in the relational database 103. A first record in the table TS is added by the above-mentioned second data addition instruction.

In addition, in a case of transmitting the data update instruction, new data is set in an existing record. Specifically, actual data is rewritten, and a size value is rewritten.

In S703 in the flow of the data addition processing illustrated in FIG. 7, the addition instruction unit 209 calculates the sizes of pieces of actual data to be added, and calculates the sum of these sizes. If the actual data is, for example, ‘id001’, a size value is 5 bytes. In addition, if the actual data is ‘2013-05-24’, a size value is 10 bytes. The size value of moving image data is measured from moving image data serving as a source. In addition, a size value obtained by summating these size values is calculated.

In S705, as described above, the addition instruction unit 209 generates the two data addition instructions. At this time, the addition instruction unit 209 causes a column name and actual data included in the data addition request to be included in the first data addition instruction without change. Furthermore, the addition instruction unit 209 causes the size column RS and the size value calculated in S703 to be included in the second data addition instruction.

The transmission unit 203 transmits the two data addition instructions to the relational database 103 (S707).

In addition, in S803 in the flow of the data update processing illustrated in FIG. 8, the update instruction unit 211 calculates the sizes of pieces of actual data included in a record to be updated, and calculates the sum of these sizes. The procedure of calculation is the same as in the case of S703 in FIG. 7.

In S805, the update instruction unit 211 generates two data update instructions. At this time, the update instruction unit 211 causes a column name and actual data included in the data update request to be included in the first data update instruction without change. Furthermore, the update instruction unit 211 causes the size column RS and the size value calculated in S803 to be included in the second data update instruction.

The transmission unit 203 transmits the two data update instructions to the relational database 103 (S807).

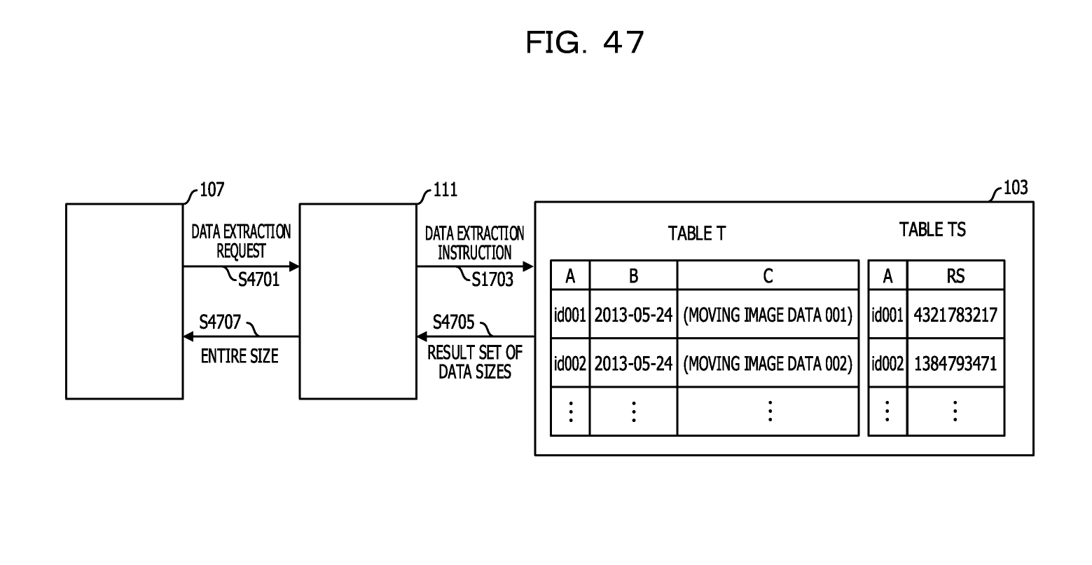

Subsequently, FIG. 47 illustrates the outline of size calculation according to the ninth embodiment. In the same way as in S1901 in FIG. 19, the application unit 107 transmits a data extraction request to the mediation unit 111 (S4701). In the same way as in the sixth embodiment, the data extraction request includes an extraction condition and an output item. A case where the output table is specified means that all pieces of actual data included in a table are acquired.

The mediation unit 111 generates a data extraction instruction (SELECT) for acquiring a size value from the size column RS, and transmits the data extraction instruction (SELECT) to the relational database 103 (S4703).

The relational database 103 transmits a result set of data sizes to the mediation unit 111 (S4705). The mediation unit 111 calculates the sum of the data sizes, and transmits the result thereof to the application unit 107 (S4707).

In S1103 within the flow of the first size calculation processing illustrated in FIG. 11, a data extraction instruction for acquiring a size value from the size column RS in the table TS is generated. For example, such a data extraction instruction as “SELECT RS FROM TS WHERE A=id001” is generated.

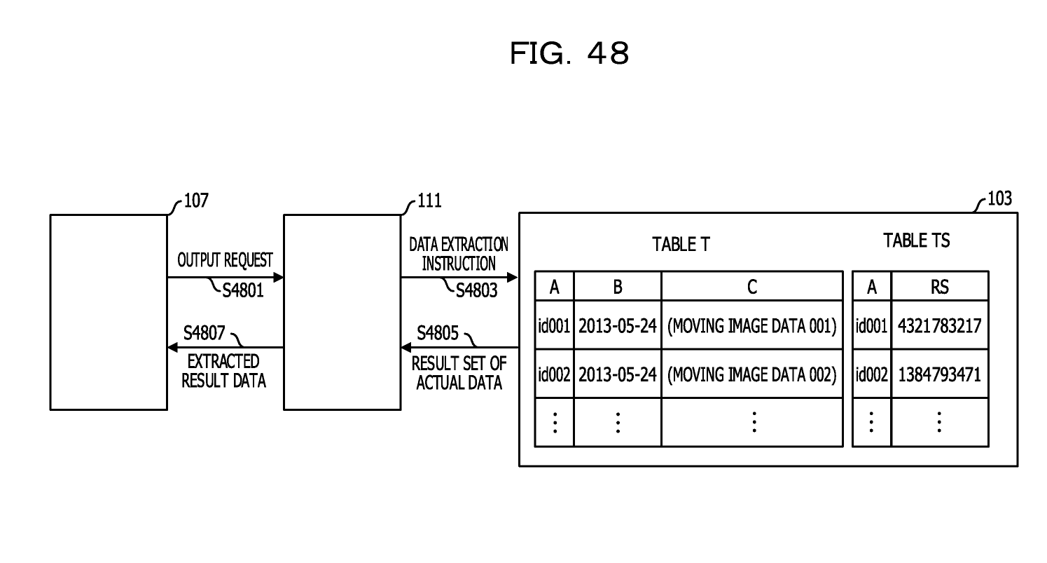

FIG. 48 illustrates the outline of actual data acquisition according to the ninth embodiment. The application unit 107 transmits an output request to the mediation unit 111 (S4801).

The mediation unit 111 generates and transmits a data extraction instruction (SELECT) for acquiring actual data, to the relational database 103 (S4803).

The relational database 103 transmits a result set of actual data to the mediation unit 111 (S4805). The mediation unit 111 generates and transmits extraction result data, to the application unit 107 (S4807).

The first actual data acquisition processing is as illustrated in FIG. 13.

According to the present embodiment, since the record-based size value is set, processing for obtaining the size of data extracted from the relational database 103 in units of records is performed at high speed. In addition, since a table storing therein actual data does not have to be rewritten, it is possible to set a size value while not changing an already existing table.

### Tenth Embodiment

In the present embodiment, an example altered, based on the ninth embodiment, so that whether to continue processing is determined on the mediation device 109 side will be described.

The module configuration of the mediation unit 111 is as illustrated in FIG. 23.

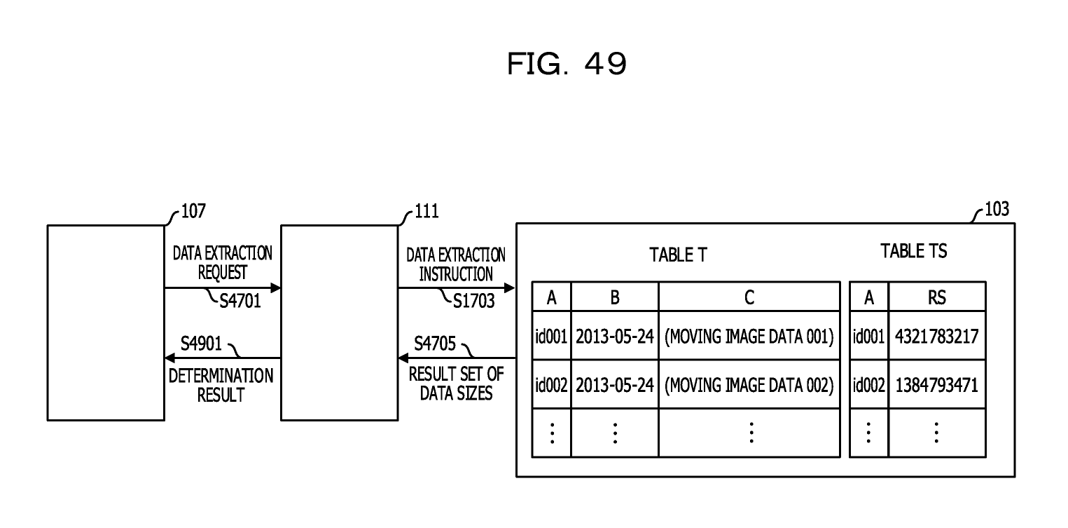

FIG. 49 illustrates the outline of determination of availability of outputting according to the tenth embodiment. FIG. 49 is based on the above-mentioned example of FIG. 47. The application unit 107 transmits a data extraction request to the mediation unit 111 (S4701). This processing operation is the same as that in the case of FIG. 47.

The mediation unit 111 generates a data extraction instruction (SELECT) for acquiring a size value from a size column, and transmits the data extraction instruction (SELECT) to the relational database 103 (S4703). This processing operation is the same as that in the case of FIG. 47.

The relational database 103 transmits a result set of data sizes to the mediation unit 111 (S4705). This processing operation is the same as that in the case of FIG. 47.

The mediation unit 111 calculates the sum of data sizes. In addition, the mediation unit 111 compares the sum of data sizes with a threshold value, and determines availability of outputting of result data. Specifically, in a case where the sum of data sizes exceeds the threshold value, the mediation unit 111 determines that outputting of the result data is unavailable. In a case where the sum of data sizes does not exceed the threshold value, the mediation unit 111 determines that outputting of the result data is available.

The mediation unit 111 transmits that determination result to the application unit 107 (S4901).

In a case of determining that outputting of the result data is available, the mediation unit 111 receives an output request from the application unit 107. On the other hand, in a case of determining that outputting of the result data is unavailable, the mediation unit 111 may be allowed not to receive an output request from the application unit 107. This is the end of the description of the outline of the determination of availability of outputting according to the present embodiment.

Data extraction in the present embodiment will be described. As illustrated in FIG. 26, in the second data extraction processing, the calculation unit 217 in the extraction instruction unit 213 executes the first size calculation processing or the second size calculation processing (S2601), and, based on a calculated data size, the determination unit 2301 in the extraction instruction unit 213 executes the first determination processing of availability of outputting (S2603). In addition, the second acquisition unit 219 in the extraction instruction unit 213 executes the first actual data acquisition processing (S903).

In a case where the first size calculation processing illustrated in FIG. 11 is executed, an entire size is transmitted in S1111. In a case where the second size calculation processing illustrated in FIG. 27 is executed, the transmission processing of the entire size illustrated in S1111 in FIG. 11 is omitted.

The first determination processing of availability of outputting is the same as an example of the fourth embodiment described using FIG. 28.

The first actual data acquisition processing is the same as in the case of the ninth embodiment.

By doing this, even in a case where record-based data sizes are set in another table in such a way as in the ninth embodiment, it is possible for the mediation unit 111 to determine availability of outputting of data, in such a way as in the fourth embodiment.

### Eleventh Embodiment

In the present embodiment, an example altered, based on the ninth embodiment, so that the actual data acquisition processing is executed in the mediation device 109, based on a determination result, will be described.

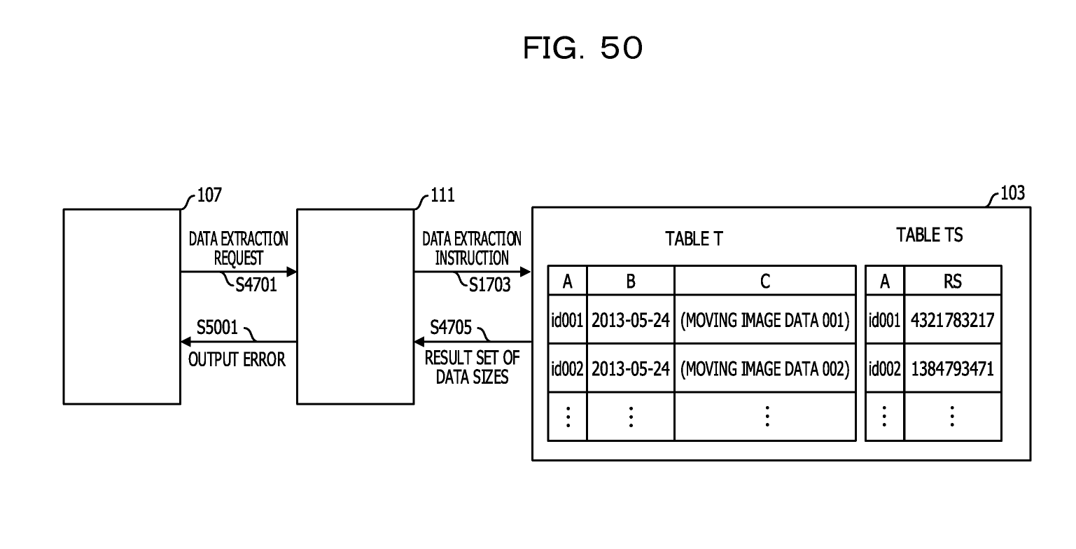

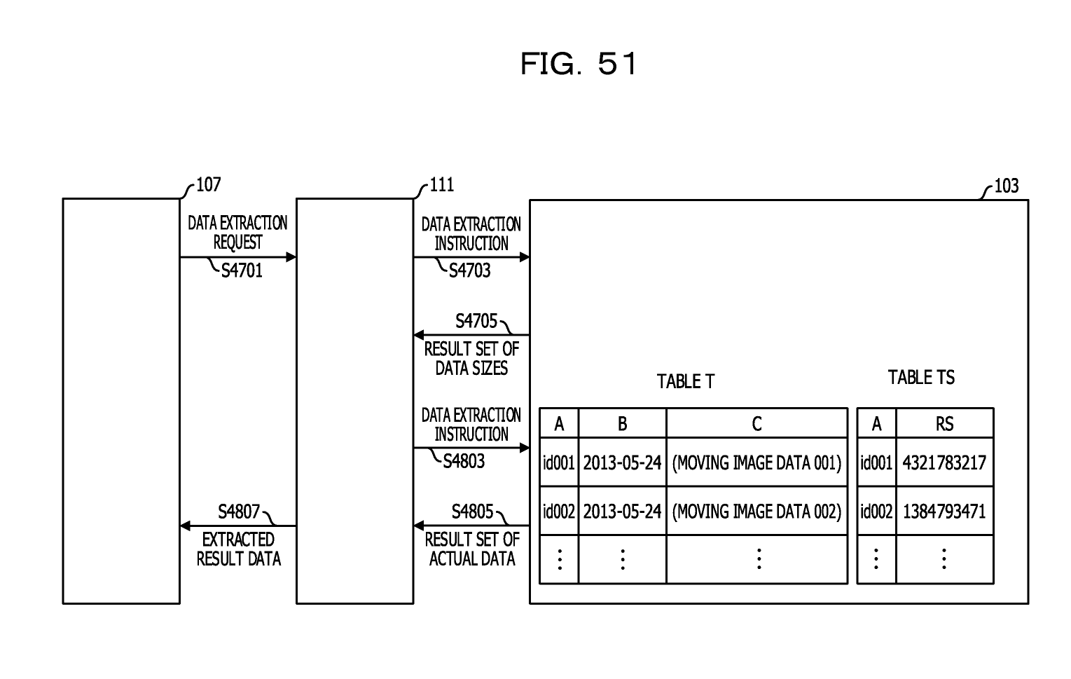

Using FIG. 50 and FIG. 51, an example of an operation based on FIG. 47 illustrated in the ninth embodiment will be described. In FIG. 50, an operation where a determination result becomes “being unable to be output” and the mediation unit 111 notifies the application unit 107 of an output error will be described.

The application unit 107 transmits a data extraction request to the mediation unit 111 (S4701). This processing operation is the same as that in the case of FIG. 47.

The mediation unit 111 generates a data extraction instruction (SELECT) for acquiring a size value from a size column, and transmits the data extraction instruction (SELECT) to the relational database 103 (S4703). This processing operation is the same as that in the case of FIG. 47.

The relational database 103 transmits a result set of data sizes to the mediation unit 111 (S4705). This processing operation is the same as that in the case of FIG. 47.

The mediation unit 111 calculates the sum of data sizes. In addition, the mediation unit 111 compares the sum of data sizes with a threshold value, and determines availability of outputting of result data. This processing is the same as that in the case of FIG. 47.

In a case where the mediation unit 111 determines that outputting of the result data is unavailable, an output error is transmitted to the application unit 107 (S5001).

Next, using FIG. 51, an operation where a determination result becomes “being able to be output” and the mediation unit 111 acquires actual data will be described. S4701 to S4705 are the same as those in the above-mentioned FIG. 50. In addition, that the mediation unit 111 calculates the sum of data sizes is the same as in the above-mentioned FIG. 50.

In a case of determining that outputting of the result data is available, the mediation unit 111 generates and transmits a data extraction instruction (SELECT), to the relational database 103 in the same way as in the case of FIG. 48 (S4803).

The relational database 103 transmits a result set of actual data to the mediation unit 111 in the same way as in the case of FIG. 48 (S4805).

The mediation unit 111 acquires actual data from the result set of actual data, changes the actual data to a predetermined format, and transmits the actual data to the application unit 107 in the same way as in the case of FIG. 48 (S4807).

The flow of processing according to the present embodiment is the same as that in the case of the fifth embodiment described using FIG. 33 to FIG. 35. In this regard, however, S1101 to S1109 in the flow of the second size calculation processing in FIG. 27 are the same as those in the ninth embodiment. In addition, S1303 to S1309 in the flow of the second actual data acquisition processing in FIG. 35 are the same as those in the ninth embodiment.

In the present embodiment, it is possible to execute data acquisition processing where outputting of data from the relational database 103 is predicted to succeed. Accordingly, it is possible to avoid a situation that outputting of extracted data is interrupted. In addition, it is possible to omit determination relating to a data size, performed by the application unit 107.

While the embodiments of the present technology have been described, the present technology is not limited to these. For example, the above-mentioned functional block configuration does not coincide with an actual program module configuration in some cases.

In addition, the configuration of each storage area described above is an example, and may be a configuration different from the above-mentioned configuration. Furthermore, in each of the flows of processing, the order of processing operations may be shuffled if a processing result does not change. Furthermore, processing operations may be executed in parallel.

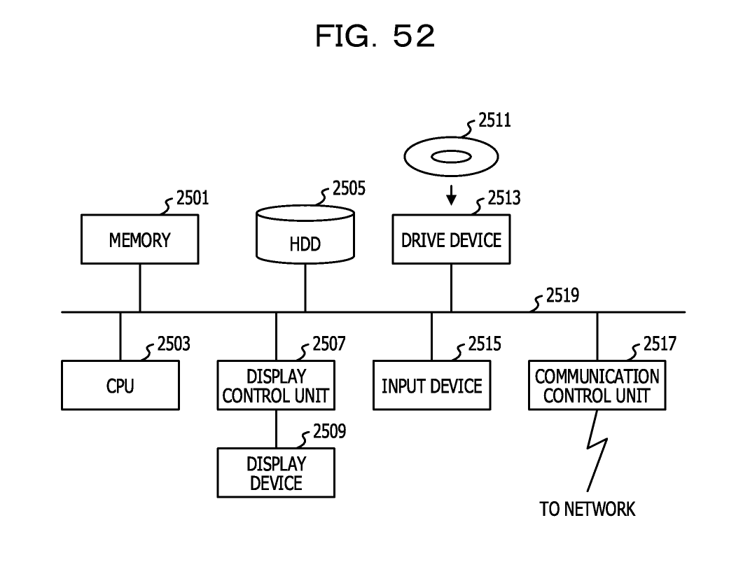

In addition, each of the mediation device 109 and the application device 105, described above, is a computer device, and as illustrated in FIG. 52, a memory 2501, a central processing unit (CPU) 2503, a hard disk drive (HDD) 2505, a display control unit 2507 connected to a display device 2509, a drive device 2513 for a removable disk 2511, an input device 2515, and a communication control unit 2517 for connecting to a network are connected to one another through a bus 2519. An operating system (OS) and an application program for implementing processing operations in the present embodiments are stored in the HDD 2505, and read out from the HDD 2505 to the memory 2501 when being executed by the CPU 2503. In accordance with the contents of processing of the application program, the CPU 2503 controls the display control unit 2507, the communication control unit 2517, and the drive device 2513 and causes predetermined operations to be performed. In addition, while data in processing is mainly stored in the memory 2501, the data in processing may be stored in the HDD 2505. In the embodiments of the present technology, the application program for implementing the above-mentioned processing operations is stored in the computer-readable removable disk 2511 and distributed, and is installed from the drive device 2513 into the HDD 2505. In some cases, the application program is installed into the HDD 2505 through a network such as the Internet, and the communication control unit 2517. Pieces of hardware such as the CPU 2503 and the memory 2501, described above, and programs such as the OS and the application program organically collaborate with one another, and hence, such a computer device realizes various kinds of functions.

The above-mentioned embodiments of the present technology are summarized as follows.

An information processing method according to one of the present embodiments includes (A) calculation processing where, from a storage unit that stores therein data and data size information indicating a data size of the data while associating the data and the data size information with each other, data size information associated with the data corresponding to a result of a query is referenced, and a data amount of the data corresponding to the result of a query is calculated based on the referenced data size information, and (B) processing where availability of outputting of the data corresponding to the result of a query is determined based on the calculated data amount and an amount of data able to be output from the storage unit.

By doing this, it is possible to predict availability of outputting of data extracted from the storage unit (for example, a database) storing therein data. It is possible to avoid, for example, a situation that outputting of extracted data is interrupted.

In addition, the above-mentioned information processing method may include processing for acquiring the data corresponding to the result of a query in a case where it is determined that outputting of the data is available.

By doing this, it is possible to execute data acquisition processing where outputting of data from the storage unit is predicted to succeed.

In addition, the storage unit may store therein each piece of item data included in the data and item data size information indicating a data size of the item data while associating the item data and the item data size information with each other. Furthermore, in the above-mentioned calculation processing, the data amount of the data corresponding to the result of a query may be calculated based on the item data size information.

By doing this, it is possible to correctly obtain the amount of actually extracted data, based on an item-based data size.

In addition, the above-mentioned information processing method may include processing for transmitting the calculated data amount.

By doing this, it is possible to predict the amount of data extracted from the storage unit. For example, on a user side, it is easy to predict a time taken to transmit data.

In addition, the above-mentioned information processing method may include processing for acquiring the data corresponding to the result of a query in a case where an output request is received. Furthermore, the above-mentioned information processing method may include processing for transmitting the acquired data.

By doing this, it is possible to select execution of data transmission, based on determination on the user side. For example, in a case where an entire size is large, it is possible to avoid the data transmission.

In addition, the above-mentioned information processing method may include processing where, in the storage unit, a field for storing therein the data size information according to the data is set in a table different from a table including the data.

By doing this, it is possible to provide the data size information while not altering the table including the data. For example, it becomes possible to add the size data information to a currently operated database.

In addition, it is possible to create a program for causing a computer to perform processing based on the above-mentioned method, and the program may be stored in a computer-readable storage medium or a storage device, such as, for example, a flexible disk, a CD-ROM, a magnet-optical disk, a semiconductor memory, or a hard disk. In addition, in general, an intermediate processing result is temporarily stored in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable medium including a program, which when executed by a computer, causes the computer to execute a process, the process comprising:
referring to data-size information indicating size of data corresponding to a query for acquiring the data stored in a storage, the data-size information and the data being stored in the storage and the data-size information being associated with the data in the storage;
specifying an amount of the data corresponding to the query in accordance with the data-size information; and
determining whether allows an output of the data corresponding to the query in accordance with the specified amount of the data and a data amount acceptable for the storage.

2. The non-transitory computer-readable medium of claim 1, wherein the process comprising:
acquiring the data corresponding to the query when it is determined that the output of the data corresponding the query is allowed.

3. The non-transitory computer-readable medium of claim 1 wherein
the data includes date items and the data-size information includes data item-size information each of which indicates sizes of each of the data items.

4. The non-transitory computer-readable medium of claim 1, wherein the process comprising:
notifying the specified amount of the data corresponding to the query.

5. The non-transitory computer-readable medium of claim 4, wherein the process comprising:
acquiring the data corresponding to the query when receives a output request; and
outputting the acquired data.

6. The non-transitory computer-readable medium of claim 1, wherein the process comprising:
setting a field to store the data-size information in a first table different from a second table including the data.

7. An apparatus comprising:
a memory; and
a processor coupled to the memory and configured to:
refer to data-size information indicating size of data corresponding to a query for acquiring the data stored in a storage, the data-size information and the data being stored in the storage and the data-size information being associated with the data in the storage;
specify an amount of the data corresponding to the query in accordance with the data-size information; and
determine whether allows an output of the data corresponding to the query in accordance with the specified amount of the data and a data amount acceptable for the storage.

8. A method comprising:
referring to data-size information indicating size of data corresponding to a query for acquiring the data stored in a storage, the data-size information and the data being stored in the storage and the data-size information being associated with the data in the storage;
specifying an amount of the data corresponding to the query in accordance with the data-size information; and
determining whether allows an output of the data corresponding to the query in accordance with the specified amount of the data and a data amount acceptable for the storage.
